(19) United States
(12) Patent Application Publication
(10) Pub. No.: US 2024/0174929 A1
(43) Pub. Date: May 30, 2024

(54) PROCESS AND SYSTEM FOR FEEDING SOLID HYDROCARBONACEOUS MATERIALS TO BUBBLING FLUID BED REACTORS

(71) Applicant: Anellotech, Inc., Pearl River, NY (US)

(72) Inventors: Karl-Ernst Wirth, Happurg (DE); Michael Missalla, Oberursel (DE); Leslaw Mleczko, Dormagen (DE); Omar Basha, Wilmington, DE (US)

(21) Appl. No.: 18/521,002

(22) Filed: Nov. 28, 2023

Related U.S. Application Data
(60) Provisional application No. 63/428,724, filed on Nov. 29, 2022.

(51) Int. Cl. C10G 1/08

(52) U.S. Cl. CPC C10G 1/086; C10G 2400/20; C10G 2400/30

(57) ABSTRACT

Processes of catalytically pyrolyzing solid hydrocarbonaceous materials in a downflow fluid bed reactor and regenerating the catalyst in an upflow fluidized bed reactor are described. Systems and compositions useful in the catalytic pyrolysis of plastics are also described.

### RELATED APPLICATIONS

This application claims the priority benefit of U.S. Provisional Patent No. 63/428,724 filed 29 Nov. 2022.

### FIELD OF THE INVENTION

This invention relates to the conversion of solid materials to useful chemical and fuel products such as paraffins, olefins, and aromatics in a catalytic pyrolysis process wherein the feed is introduced at the top of a bubbling catalytic fluid bed.

### BACKGROUND

Of the estimated 44 million metric tons of plastic waste managed in 2019 in the USA, approximately 86% was landfilled, 9% was combusted, and 5% was recycled, according to a 2022 study by NREL (Milbrandt et al, “Quantification and evaluation of plastic waste in the United States,” Resources, Conservation & Recycling, 183, August 2022). World-wide over 368 million tons of plastics were produced. By some estimates, of the 8.3 billion tons of plastics ever produced, 6.3 billion tons ended up as waste, of which only 9% has been recycled. Plastic recycling recovers scrap or waste plastic and reprocesses the material into useful products. However, since China banned the import of waste plastics in 2018 the recycle rate in the US is estimated to have dropped to only 4.4%.

Plastic recycling is challenging due to the chemical nature of the long chain organic polymers and low economic returns. In addition, waste plastic materials often need sorting into the various plastic resin types, e.g. low density polyethylene (LDPE), high density polyethylene (HDPE), polypropylene (PP), polystyrene (PS), polyvinyl chloride (PVC), and polyethylene-terephthalate (PET) for separate recycling treatments. Pyrolytic and catalytic pyrolytic processes are known in which waste plastics are heated to produce products such as liquid oils, gases, and carbon black. Plas-TCat™ is a catalytic fluid bed process using zeolite catalysts for converting solid, hydrocarbonaceous feedstocks comprising polymer/plastic material, and optionally biomass, to a mixed product of permanent gases, C2-C4 light olefins, C1-C4 light paraffins, and C5+ hydrocarbons including benzene, toluene, and xylenes (“BTX”), aromatic and non-aromatic naphtha range molecules, C11+ hydrocarbons, coke and char, and minor byproducts. Conversion occurs in a fluid bed reactor using ZSM-5 zeolite or similar catalyst. A portion of the light gases produced by the reaction may be recycled to the reactor to provide fluidization gas and for feedstock injection into the vessel. Coke and char by-products that accumulate on the catalyst and temporarily deactivate it are removed by oxidation in a continuously operating catalyst regenerator. Solid materials which can be processed by Plas-TCat™ include biomass, waste tires, lubricating oils, coal, and petroleum residues in addition to plastics.

Feeding solids to fluid bed reactors in a uniform manner can be problematic when the solids are susceptible to melting or decomposition to form oily or viscous liquid materials or tars, such as with biomass or plastics. There is a strong tendency for the sticky molten feed materials to agglomerate into larger particles that may also contain particles of catalyst. The larger agglomerates of feed react more slowly, can cause de-fluidization, and tend to form char or coke. Since plastics and other carbonaceous materials have low packed density, the particles tend to ‘float’ on the surface of the bubbling bed, limiting contact with the catalyst and enhancing agglomeration. A variety of methods have been developed to feed solids that attempt to overcome or avoid this problem.

The two most common ways to feed reactive solids such as plastics or biomass into fluidized bed reactors are with screw augers or gas jets. In each of these cases the solids must be kept relatively cool (<200° C. ) before entering the bed, such that active cooling is required when the fluid bed materials are at high temperatures (>250° C. ) Gas jet injection has a further limitation since the gas used to propel the solids into the bed becomes part of the vapor product mixture, diluting useful products, and increasing separations costs. Moreover, gas jet injection is limited to small particles, typically less than 1 mm in diameter, and particle size reduction can be costly and energy intensive. Screw augers do not facilitate uniform mixing of the solids with the materials in the fluid bed. A need exists to develop a means of uniformly feeding larger size solids into fluid bed reactors. It is an object of the present disclosure to provide a system for distributing solids to the top of a bubbling catalytic fluid bed for the conversion of solid hydrocarbonaceous materials to useful chemical and fuel products such as paraffins, olefins, and BTX.

### SUMMARY OF THE INVENTION

In a first aspect, the invention provides a process for converting solid hydrocarbonaceous materials to useful products comprising: feeding solid hydrocarbonaceous materials into a fluidized bed catalytic pyrolysis reactor containing a solid conversion catalyst by means of a feed system that includes a particle distribution device that spreads feed particles over the surface of the bed, reacting the hydrocarbonaceous materials to form vapor products, withdrawing and recovering the vapor products, and recovering olefins, aromatics, or both, from the vapor products.

The invention, in any of its aspects, can be further characterized by one or any combination of the following features: wherein the solid hydrocarbonaceous materials are selected from among polyethylene (PE), polypropylene (PP), polyacetylene, polybutylene, polyolefins, polyethylene terephthalate (PET), polybutylene terephthalate, copolyesters, polyester, polycarbonate, polyurethanes, polyamides, polystyrene (PS), polyacetal, epoxies, polycyanurates, polyacrylics, polyurea, vinyl esters, polyacrylonitrile, polyvinyl alcohol, polyvinylchloride (PVC), poly(methyl methacrylate) (PMMA), polyvinyl acetate, nylon, copolymers such as: ethylene-propylene, EPDM, acrylonitrile-butadiene-styrene (ABS), nitrile rubber, natural and synthetic rubber, tires, styrene-butadiene, styrene-acrylonitrile, styrene-isoprene, styrene-maleic anhydride, ethylene-vinyl acetate, nylon 12/6/66, filled polymers, polymer composites, polymer composites comprising natural fibers, plastic alloys, other polymeric materials, whether obtained from polymer or plastic manufacturing processes as waste or discarded materials, post-consumer recycled polymer materials, biomass, materials separated from waste streams such as municipal solid waste, black liquor, wood waste, or other biologically produced materials, or a combination of these; wherein the solid hydrocarbonaceous material comprises material selected from among polyethylene, polypropylene, and polystyrene, or mixtures thereof; wherein the solid hydrocarbonaceous material comprises waste plastics; wherein the solid hydrocarbonaceous material is pretreated before being fed to the catalytic pyrolysis reactor; wherein the solid hydrocarbonaceous material is dried to achieve a moisture content of no more than 20, or 10, or 5 wt % moisture; wherein the solid hydrocarbonaceous material is comminuted to particles no larger than 50, 20, 10, 5, 2, or 1 cm in their longest dimension; wherein the solid hydrocarbonaceous material is washed with water, or acid, or base, or by a sequence of more than one washing with one or more wash solutions; wherein at least a portion of the chlorine-containing plastics are selectively removed from the feed mixture; wherein the solid hydrocarbonaceous materials comprise from 30 to 100, from 40 to 80, or from 45 to 70, or at least 30, at least 40, or at least 45, or less than 99, less than 95, or less than 80 percent by mass of a combination of polyethylene (PE) (sum of low- and high-density polyethylene), polypropylene (PP), and polystyrene (PS); wherein the solid hydrocarbonaceous materials comprise from 1 to 30, 2 to 20, or 3 to 10, or up to 30, up to 20, or up to 10, or at least 0.1, at least 1, or at least 2% by mass biomass; wherein the solid hydrocarbonaceous materials comprise from 0.1 to 20, from 1 to 15, or from 3 to 10, or at least 0.1, at least 1, or at least 3, or less than 20, less than 15, or less than 10 percent by mass polyethylene terephthalate (PET); wherein the solid hydrocarbonaceous materials comprise from 0.1 to 20, from 1 to 15, or from 3 to 10, or at least 0.1, at least 1, or at least 3, or less than 20, or less than 15, or less than 10 percent by mass nylon; wherein the feed system comprises a feed hopper, a metering device, and a distributor that spreads the feed materials over the top of the fluidized bed; wherein the distributor is positioned above the fluidized bed; wherein the distributor is positioned adjacent to the fluidized bed; wherein the distributor propels the feed particles above and across the cross-section of the surface of fluidized bed reactor; wherein the distributor propels the feed particles by spinning to impart radial velocity to the particles; wherein the distributor comprises an inlet from which feed particles are fed to a rotating element that propels the feed particles above and across the bed surface; wherein the distributor comprises one or more jets that propel feed particles above and across the surface of the bubbling bed; wherein the distributor comprises a slinger belt feed system that propels the feed particles across the surface of the bubbling fluid bed; wherein the catalytic pyrolysis reaction is conducted in a fluidized bed chosen from among a bubbling bed, or turbulent bed, or some combination of these; wherein the catalytic pyrolysis reactor is a bubbling bed; wherein the fluid bed reactor comprises a fluidization fluid introduced at or near the bottom of the bed; wherein from 5 to 5000, from 5 to 2500, or from 100 to 1500, or at least 25, or at least 100 metric tons per day (mtpd) of solid hydrocarbonaceous materials are processed in the catalytic pyrolysis reactor; wherein the weight hourly space velocity of feed is from 0.1 to 2.0, or from 0.2 to 1.0, or from 0.25 to 0.75, at least 0.1, at least 0.2, or at least 0.25, or less than 2.0, less than 1.0, or less than 0.75 hr^{-1;} wherein the residence time of an average carbon atom within the catalytic pyrolysis reactor is from 0.5 to 180, from 2 to 100, from 4 to 80, from 10 to 60, or from 30 to 60, or at least 5, at least 10, or at least 30, or less than 180, less than 100, less than 80, or less than 60 seconds; wherein the catalytic pyrolysis reactor is a fluidized bed reactor that comprises a sparger or distributor, located at or near the bottom of the reactor, that serves to distribute a fluidization fluid; wherein the superficial inlet gas velocity of the fluidization fluid entering the reactor is from 0.05 to 1.0, from 0.1 to 0.7, or from 0.2 to 0.5, or at least 0.1, at least 0.2, or at least 0.3, or less than 1.0, less than 0.7, or less than 0.5 meters per second; wherein the fluidization fluid is an inert gas, a hydrocarbon gas, or a recycle stream separated from the products, or a combination thereof; wherein the catalytic pyrolysis reactor is from 0.1 to 15, from 0.3 to 10, or from 3 to 7, or at least 3, or at least 5 meters in diameter; wherein the height/diameter ratio (H:D) of the catalytic pyrolysis reactor is from 0.5:1 to 10:1, from 1:1 to 8:1, or from 1.5:1 to 5:1, or at least 1:1, at least 1.5:1, or at least 2:1, or less than 15:1, less than 10:1, or less than 5:1; wherein the catalytic pyrolysis is conducted at an operating temperature in the range from 450 to 750, from 500 to 650, or from 550 to 600, or at least 450, at least 500 or at least 550, or no more than 750, or no more than 650° C.; wherein the pressure in the catalytic pyrolysis reactor is from 0.5 to 10, 1.0 to 6, or 1.5 to 4, or at least 1, at least 1.5 or at least 2, or less than 20, less than 10, or less than 6 barg; wherein the internal diameter of the catalytic pyrolysis reactor increases along at least a portion of the height of the reactor; wherein the internal diameter of the catalytic pyrolysis reactor increases along at least a portion of the height of the reactor, the portion being shaped like a cone where the angle of the wall of the cone with respect to vertical can range from 3 degrees to 50 degrees, from 5 to 40, from 7 to 25, or from 8 to 15, or at least 3, at least 7, at least 8 degrees, or at least 10 degrees from vertical, where vertical is defined as zero degrees; wherein the catalytic pyrolysis reactor comprises a conical portion of the reactor that includes at least the height of the dense bubbling phase of the fluid bed; wherein the catalytic pyrolysis reactor comprises a conical portion and wherein any additional height of the reactor above the top of the dense bubbling phase of the fluid bed is cylindrical; wherein the catalytic pyrolysis reactor comprises a conical portion and wherein the ratio of the superficial velocity of the vapors at the top of the conical portion of the reactor is no more than 1.01:1, no more than 1.5:1, no more than 2.0:1, no more than 2.5:1, or no more than 3.0:1, or from 1.01:1 to 3.0:1, or from 1.1:1 to 2.0:1 compared to the superficial velocity of the vapors at the bottom of the conical portion of the reactor; wherein used catalyst and solids are withdrawn from the catalytic reactor, wherein at least a portion of the withdrawn used catalyst and any solids are fed to a catalyst regenerator, wherein the catalyst is regenerated in the regenerator by combusting any carbon or carbonaceous materials with air or other oxygen-containing gas; wherein at least a portion of the hot, regenerated catalyst is returned to the fluidized bed catalytic pyrolysis reactor; wherein hot, regenerated catalyst from the regenerator is returned to the fluidized bed at a temperature at least 100° C., 150° C., 200° C., or 250° C. greater than the average temperature of the fluidized bed; wherein the vapor products are separated from entrained catalyst and solids in one or more cyclones; wherein at least a portion of the catalyst recovered in the cyclones is returned to the reactor; wherein heat from the catalyst regenerator is used to heat the solid feed materials or fluidization fluid or both; wherein a portion of regenerated catalyst is removed from the separated stream of regenerated catalyst and discarded; wherein regenerated catalyst is removed and discarded each day in an amount from 0.1 to 5.0, from 0.5 to 4.0, or from 1.0 to 3.0%, or at least 0.1, at least 0.5, or at least 1%, or no more than 5.0, no more than 4.0, or no more than 3.0% by mass of the separated, regenerated catalyst each day; wherein fresh catalyst is added to the catalytic pyrolysis reactor with the regenerated catalyst or from a separate conduit or some combination of these; wherein fresh catalyst is added to the catalytic pyrolysis reactor in an amount of fresh catalyst that is from 0.1 to 5.0, from 0.5 to 4.0, or from 1.0 to 3.0%, or at least 0.1, at least 0.5, or at least 1%, or no more than 5.0, no more than 4.0, or no more than 3.0% by mass of the separated, regenerated catalyst each day; wherein the mass flow rate of the hot, regenerated catalyst recycle stream is from 3 to 1700, or from 170 to 845, or at least 60, at least 150 or at least 310, or less than 170, less than 360 or less than 845 kg/s; wherein the mass flow rate of the hot regenerated catalyst into the catalytic pyrolysis reactor, when defined as the amount of catalyst added per unit time divided by the amount of catalyst in the bed, is from 0.025% per second to 5% per second, or from 0.1% per second to 3.5% per second, or at least 0.5% per second, at least 1.5% per second, or at least 3% per second, or less than 7% per second; wherein the vapor products from the catalytic pyrolysis comprise from 1-70 wt %, 5-65 wt %, 10-60 wt %, 20-50 wt %, 30-45 wt %, 40-65 wt %, or 50-70 wt %, or at least 20 wt %, at least 30 wt %, at least 40 wt %, at least 50 wt %, or at least 60 wt % C2-C4 alkenes; wherein the vapor products from the catalytic pyrolysis comprise from 1-70 wt %, 5-65 wt %, 10-60 wt %, 20-50 wt %, 30-45 wt %, 40-65 wt %, or 50-70 wt %, or at least 20 wt %, at least 30 wt %, at least 40 wt %, at least 50 wt %, or at least 60 wt % the sum of C2-C4 alkanes plus C2-C4 alkenes; wherein the catalyst comprises a zeolite; wherein the catalyst comprises a zeolite material with average pore sizes of less than 10, less than 5, less than 2, less than 1, less than 0.65, or between 0.5 and 10 nanometers; wherein the catalyst comprises a zeolite material with average pore sizes of between 0.55 and 0.65, or between 0.59 and 0.63 nanometers; wherein the catalyst comprises a zeolite material that has a constraint index (CI) value within the range of 1 to 12; wherein the catalyst is chosen from among ferrierite, zeolite Y, zeolite beta, mordenite, MCM-22, ZSM-5, ZSM-23, ZSM-57, SUZ-4, EU-1, ZSM-11, (S)A1PO-31, SSZ-23, or a combination thereof; wherein the catalyst comprises ZSM-5; wherein the catalyst comprises a metal, a metal oxide, or both, wherein the metal is chosen from among nickel, palladium, platinum, titanium, vanadium, chromium, manganese, iron, cobalt, zinc, copper, gallium, the rare earth elements, i.e., elements 57-71, cerium, zirconium, or a combination thereof; wherein a stream enriched in ethylene or propylene, or both, is separated from the condensable materials in the vapor products; wherein an olefin-containing product stream that comprises at least 20, at least 50, or at least 70, or in the range of 20 to 95, 50 to 90, or 70 to 90 mass % olefins, or more is separated from the condensable higher materials in the vapor products; wherein the mass yield of olefins is at least 1%, at least 2.5%, at least 5%, at least 8%, or at least 10%, or no more than 80%, no more than 65%, no more than 50%, or no more than 35%, or from 1% to 80%, from 3% to 65%, from 5% to 50%, or from 10 to 35%, and the mass yield of all products is no more than 100% based on the mass in the feed; wherein a stream comprising C5+products is separated from the vapor products; wherein a stream comprising benzene, toluene, xylenes, or some combination of these (BTX) is separated and recovered from the vapor products; wherein the mass yield of BTX is at least 16%, at least 22%, at least 30%, at least 40%, at least 50%, or at least 60%, or from 15% to 75%, from 20% to 70%, or from 45% to 65%, and the mass yield of all products is no more than 100% based on the mass of solid hydrocarbonaceous materials fed to the process; wherein the mass yield of olefins plus aromatics is greater than 40%, greater than 60%, greater than 70%, greater than 75%, or greater than 80%, or from 40% to 99%, from 60% to 95%, or from 65% to 90%, and the mass yield of all products is no more than 100% based on the mass of solid hydrocarbonaceous materials fed to the process; wherein the selectivity of ethylene as a percentage of the total olefins produced is at least 20%, at least 25%, or at least 30%, or from 10% to 60%, from 20% to 45%, or from 25% to 35%, and the selectivity of propylene as a percentage of the total olefins produced is at least 20%, at least 30%, at least 40%, at least 45%, or at least 50%, or from 20% to 70%, from 25% to 65%, or from 30% to 55%, such that the total selectivity of ethylene plus propylene is less than 100; wherein the selectivity of benzene plus toluene plus xylenes (BTX) as a percentage of aromatics produced is at least 40%, at least 50%, at least 80%, at least 90%, at least 95%, or at least 97%, or from 40% to 99.9%, from 50% to 98%, from 80 to 95%, or from 90% to 95%; wherein the mass yield of coke and char from the catalytic pyrolysis is less than 10%, less than 5%, less than 2%, less than 1%, or less than 0.5%, or from 0.1% to 10%, from 0.2% to 5%, or from 0.3 to 2%, and the mass yield of all products is no more than 100% based on the mass of solid hydrocarbonaceous materials fed to the process; wherein the vapor products mixture is subjected to a separation process to produce a separated stream of gases comprising gases chosen from among any of C1 to C4 hydrocarbons, H2, CO2, and CO, or some combination thereof; and passing at least a portion of the separated stream of gases to the regenerator as part of the fluidization fluid; wherein olefins are separated from the catalytic pyrolysis products for upgrading to BTX or other valuable products, and at least a portion of the olefins are recycled to the catalytic pyrolysis reactor; wherein olefins are separated from the catalytic pyrolysis products and at least a portion of the ethylene is recycled to the catalytic pyrolysis reactor; wherein olefins are separated from the catalytic pyrolysis products for upgrading to BTX or other valuable products, and the products of the upgrading are combined with products of the catalytic process for separation and purification; wherein an oxidizing agent is fed to the regenerator via a gas feed stream; wherein the regenerator fluidization fluid is oxygen, air, recycled flue gas, steam, or some combination of these; wherein the regenerator temperature is at least 300, 400, 500, 600, 700, or 800, or from 500 to 1000, from 600 to 800, or from 650 to 700° C.; wherein the residence time of the catalyst in the regenerator is from 25 to 500, from 50 to 300, or from 75 to 150, or at least 25, at least 50, at least 75, or at least 100, or no more than 500, no more than 300 or no more than 150 seconds; wherein the solids flux, which is the rate of mass flow of solid material through a cross sectional area of the regenerator, is in the range from 19 to 300, 50 to 250, or 100 to 200, or at least 19, at least 50, at least 100, or at least 150, or no more than 300, no more than 250, or no more than 200 kg/m2s; wherein the superficial fluidization gas velocity at the entrance of the regenerator is at least 1.5, at least 2.0, at least 2.5, or at least 3.0, or from 0.6 to 7.5, from 1.0 to 6.0, from 1.5 to 5.0, from 2.5 to 4.5, or from 3.0 to 4.0, or no more than 7.5, no more than 6.5, no more than 5.0, or no more than 4.0 m/s; wherein the height-to-diameter ratio (H/D) of the regenerator is from 2 to 15, from 3 to 22, from 5 to 40, or from 10 to 44, or at least 2, at least 5, or at least 10, or no more than 10, or more than 15, no more than 30, or no more than 44; wherein at least a portion of the gases in the vapor product mixture is combusted in the regenerator.

In another aspect, the invention provides an apparatus for converting solid hydrocarbonaceous materials to useful products comprising: a feed hopper comprising solid hydrocarbonaceous materials comprising polymers or biomass or both, a fluidized bed catalytic pyrolysis reactor containing a conversion catalyst, a particle distribution device positioned to feed the solid hydrocarbonaceous materials into the fluidized bed catalytic pyrolysis reactor at a point in the reactor above the height of a dense bubbling phase of the fluid bed, a conduit adapted to feed hot regenerated catalyst at a point in the reactor above the height of the dense bubbling phase of the fluid bed, a conduit adapted to pass the vapors from the fluid bed into one or more cyclones in which entrained particles are removed, a conduit adapted to withdraw catalyst and solids from the catalytic reactor, a conduit adapted to feed used catalyst and any solids withdrawn from the catalytic reactor to a fluidized bed catalyst regenerator, a conduit adapted to withdraw hot, regenerated catalyst from the regenerator, and one or more cyclones through which the hot regenerated catalyst and combustion products can be passed to separate the solids.

The invention can be characterized as a method, apparatus, and system (comprising apparatus and fluids or conditions). The invention can be described by any part or combination of the methods, apparatus, and systems described herein. The methods, systems, and apparatus of the invention can also be conducted in conjunction with a separate thermal pyrolysis process before the catalytic conversion process. Thus, the invention can be further characterized by one or any combination of the following features: wherein a feed mixture comprising plastics is melted in a thermal pyrolysis reactor and at least a portion of the material that forms the feed to the catalytic pyrolysis reactor is a molten liquid; wherein the thermal pyrolysis reactor comprises an extruder, rotating kiln reactor, or other suitable reactor that produces a molten liquid stream; wherein the thermal pyrolysis reactor comprises an added solid; wherein the solid added to the thermal pyrolysis reactor comprise a calcium or magnesium salt; wherein the solid materials exiting the thermal pyrolysis reactor may be separated from the molten liquids and discarded; wherein solids are separated from the pyrolysis products and combusted to generate heat or energy or are discarded; wherein the thermal pyrolysis reactor is operated at temperatures from 200 to 350, from 225 to 325, or from 250 to 300, or at least 200, at least 250, or at least 200, or no more than 500, no more than 450, or no more than 400° C.; wherein the residence time of the solid feed materials in the thermal pyrolysis reactor is from 1 to 30, or from 2 to 20, or from 5 to 15, or at least 1, or at least 2, or at least 5, or no more than 30, or no more than 20 or no more than 15 minutes; wherein the pressure in the thermal pyrolysis reactor can be from 1 to 30, from 2 to 20, from 3 to 10, or at least 2, or at least 3 or at least 4, or no more than 30, or no more than 20 or no more than 10 barg; wherein the molten liquid exiting the pyrolysis reactor is chopped to form fragments that are fed to the catalytic pyrolysis reactor;

### BRIEF DESCRIPTION OF THE DRAWINGS

FIG. 1 Terminal and Minimum Fluidization Velocities of Plastic and Catalyst Particles.

FIG. 2 Schematic of Reaction System for Catalyzed Pyrolysis Using Overbed Feeding

FIG. 3 Nozzles with Conical hat distributor.

FIG. 4 Nozzle configurations for top feeding of particulates into a fluid bed reactor.

FIG. 5. Arrangement of slinger feed system used for overbed feeding.

FIG. 6. Slinger belt feeder.

FIG. 7. Slinger Wheel particle distribution device.

FIG. 8. Cold flow experimental mixing results for plastic-catalyst mixtures.

FIG. 9. Feed arrangements evaluated by CFD.

FIG. 10. Average plastic particle diameter (A) and local mixing index (B) for Top (overbed) and Bottom (underbed) fed bubbling bed reactors as calculated by CFD.

FIG. 11. Reactor performance comparing 3 cases of top feeding, bottom feeding and a perfectly mixed (“Mixed”) behavior of the plastic and catalyst.

FIG. 12. Trajectory of particles propelled by slinger belt feeder as a function of the throw angle.

FIG. 13. Cross sectional area coverage of (left) slinger belt feeder and (right) Nozzle feeder with a conical distributor.

FIG. 14. Particle distribution for a single nozzle showing the added particles (left) and the bed materials (right).

FIG. 15. Particle distribution for a multiple nozzle design showing the particles (left) and the bed material (right).

FIG. 16, Particle distribution for a slinger belt design showing the particles (left) and the bed (right).

### GLOSSARY

Aromatics—As used herein, the terms “aromatics” or “aromatic compound” are used to refer to a hydrocarbon compound or compounds comprising one or more aromatic groups such as, for example, single aromatic ring systems (e.g., benzyl, phenyl, etc.) and fused polycyclic aromatic ring systems (e.g. naphthyl, 1,2,3,4-tetrahydronaphthyl, etc.). Examples of aromatic compounds include, but are not limited to, benzene, toluene, indane, indene, 2-ethyl toluene, 3-ethyl toluene, 4-ethyl toluene, trimethyl benzene (e.g., 1,3,5-trimethyl benzene, 1,2,4-trimethyl benzene, 1,2,3-trimethyl benzene, etc.), ethylbenzene, styrene, cumene, methylbenzene, propylbenzene, xylenes (e.g., p-xylene, m-xylene, o-xylene, etc.), naphthalene, methyl-naphthalene (e.g., 1-methyl naphthalene, anthracene, 9.10-dimethylanthracene, pyrene, phenanthrene, dimethyl-naphthalene (e.g., 1,5-dimethyl naphthalene, 1,6-dimethyl naphthalene, 2,5-dimethyl naphthalene, etc.), ethyl-naphthalene, hydrindene, methyl-hydrindene, and dimethyl-hydrindene. Single-ring and/or higher ring aromatics may also be produced in some embodiments.

Fluid—The term “fluid” refers to a gas, a liquid, a mixture of a gas and a liquid, or a gas or a liquid containing dispersed solids, liquid droplets and/or gaseous bubbles. The terms “gas” and “vapor” have the same meaning and are sometimes used interchangeably. In some embodiments, it may be advantageous to control the residence time of the fluidization fluid in the catalytic pyrolysis reactor. The fluidization residence time of the fluidization fluid is defined as the volume of the reactor divided by the volumetric flow rate of the fluidization fluid under process conditions of temperature and pressure. In embodiments comprising a thermal pyrolysis reactor before the catalytic pyrolysis, the residence time of the feed in the thermal pyrolysis reactor can be calculated by the feed rate of solid hydrocarbonaceous material divided by the heated reactor volume. Fluidization gas mixtures can comprise argon, helium, nitrogen, carbon dioxide, carbon monoxide, hydrogen, methane, ethane, propane, butane, ethylene, propylene, or mixtures of these. Fluidized Bed Reactor—The term “fluidized bed reactor” is given its conventional meaning in the art and is used to refer to reactors comprising a vessel that can contain a granular solid material (e.g., silica particles, catalyst particles, etc.), in which a fluid (e.g., a gas or a liquid) is passed through the granular solid material at velocities sufficiently high as to suspend the solid material and cause it to behave as though it were a fluid. The term “circulating fluidized bed reactor” is also given its conventional meaning in the art and is used to refer to fluidized bed reactors in which the granular solid material is passed out of the reactor, circulated through a line in fluid communication with the reactor, and recycled back into the reactor. Examples of fluidized bed reactors are described in “Fluidization Engineering”, D. Kunii and O. Levenspiel, 2nd Ed. Butterworth-Heinemann, 1991, pp 1-236.

Bubbling fluidized bed reactors and turbulent fluidized bed reactors are also known to those skilled in the art. In bubbling fluidized bed reactors, the fluid stream used to fluidize the granular solid material is operated at a sufficiently low flow rate such that bubbles and voids are observed within the volume of the fluidized bed during operation. For bubbling fluidized beds there is an observable particulate zone with a top boundary and a zone above containing few particles. In turbulent fluidized bed reactors, the flow rate of the fluidizing stream is higher than that employed in a bubbling fluidized bed reactor, and hence, bubbles and voids are not observed within the volume of the fluidized bed during operation. Examples of bubbling and turbulent fluidized bed reactors are described in “Fluidization Engineering”, D. Kunii and O. Levenspiel, 2nd Ed. Butterworth-Heinemann, 1991, pp 1-236, incorporated herein by reference.

Olefins—The terms “olefin” or “olefin compound” (a.k.a. “alkenes”) are given their ordinary meaning in the art and are used to refer to any unsaturated hydrocarbon containing one or more pairs of carbon atoms linked by a double bond. Olefins include both cyclic and acyclic (aliphatic) olefins, in which the double bond is located between carbon atoms forming part of a cyclic (closed-ring) or of an open-chain grouping, respectively. In addition, olefins may include any suitable number of double bonds (e.g., monoolefins, diolefins, triolefins, etc.). Examples of olefin compounds include, but are not limited to, ethene, propene, allene (propadiene), 1-butene, 2-butene, isobutene (2 methyl propene), butadiene, and isoprene, among others. Examples of cyclic olefins include cyclopentene, cyclohexane, cycloheptene, among others. Aromatic compounds such as toluene are not considered olefins; however, olefins that include aromatic moieties are considered olefins, for example, benzyl acrylate or styrene.

Catalysts—Catalyst components useful in the context of this invention can be selected from any catalyst known in the art, or as would be understood by those skilled in the art. Catalysts promote and/or effect reactions. Thus, as used herein, catalysts lower the activation energy (increase the rate) of a chemical process, and/or improve the distribution of products or intermediates in a chemical reaction (for example, a shape selective catalyst). Examples of reactions that can be catalyzed include: dehydration, dehydrogenation, isomerization, hydrogen transfer, hydrogenation, polymerization, cyclization, desulfurization, denitrogenation, deoxygenation, aromatization, decarbonylation, decarboxylation, aldol condensation, and combinations thereof. Catalyst components can be considered acidic, neutral, or basic, as would be understood by those skilled in the art.

For catalytic pyrolysis, particularly advantageous catalysts include those containing internal porosity selected according to pore size (e.g., mesoporous and pore sizes typically associated with zeolites), e.g., average pore sizes of less than 10, less than 5, less than 2, less than 1, less than 0.65 nanometers, or smaller. In some embodiments, catalysts with average pore sizes of from 0.5 to 10 nanometers may be used. In some embodiments, catalysts with average pore sizes of between about 0.55 and 0.65, or between 0.59 and 0.63 nanometers may be used. In some cases, catalysts with average pore sizes of between 0.7 and 0.8, or between 0.72 and 0.78 nanometers may be used. Preferably, the catalyst is be selected from naturally occurring zeolites, synthetic zeolites and combinations thereof. In certain embodiments, the catalyst may be a ZSM-5 zeolite catalyst, as would be understood by those skilled in the art, which can include the proton form of ZSM-5 sometimes written as HZSM-5, or any form wherein protons have been substituted at least in part with metal cations. Optionally, such a catalyst can comprise acidic sites. Other types of zeolite catalysts include: ferrierite, zeolite Y, zeolite beta, mordenite, MCM-22, ZSM-23, ZSM-57, SUZ-4, EU-1, ZSM-11, (S)AIPO-31, SSZ-23, among others. Zeolites and other small pore materials are often characterized by their Constraint Index (CI). The method by which Constraint Index is determined is described more fully in U.S. Pat. No. 4,029,716, incorporated by reference for details of the method. The CI preferably has a value for any given molecular sieve useful herein within the approximate range of 1 to 12. In other embodiments, non-zeolite catalysts may be used; for example, WOx/ZrO2, aluminum phosphates, etc. In some embodiments, the catalyst may comprise a metal and/or a metal oxide chosen from among nickel, palladium, platinum, titanium, vanadium, chromium, manganese, iron, cobalt, zinc, copper, gallium, the rare earth elements, i.e., elements 57-71, cerium, zirconium, and/or any of their oxides, or some combination thereof. In addition, in some cases, properties of the catalysts (e.g., pore structure, type and/or number of acid sites, etc.) may be chosen to selectively produce a desired product.

Plastics or Polymers—The terms “plastics” and “polymers” are used interchangeably herein. A polymer is a carbon-based (at least 35 mass % C) material chiefly made up of repeating units and having a number average molecular weight of at least 100, typically greater than 1000 or greater than 10,000.

Pyrolysis—The terms “pyrolysis” and “pyrolyzing” are given their conventional meaning in the art and are used to refer to the transformation of a compound, e.g., a solid hydrocarbonaceous material, into one or more other substances, e.g., volatile organic compounds, gases, and coke, by heat, preferably without the addition of, or in the absence of, O2. Preferably, the volume fraction of O2 present in a pyrolysis reaction chamber is 0.5% or less. Pyrolysis may take place with or without the use of a catalyst. “Catalytic pyrolysis” refers to pyrolysis performed in the presence of a catalyst and may involve steps as described in more detail below. Example of catalytic pyrolysis processes are outlined, for example, in Huber, G. W. et al, “Synthesis of Transportation Fuels from Biomass: Chemistry, Catalysts, and Engineering,” Chem. Rev. 106, (2006), pp. 4044-4098.

Selectivity—The term “selectivity” refers to the amount of production of a particular product in comparison to a selection of products. Selectivity to a product may be calculated by dividing the amount of the particular product by the amount of a number of products produced. For example, if 75 grams of aromatics are produced in a reaction and 20 grams of benzene are found in these aromatics, the selectivity to benzene amongst aromatic products is 20/75=26.7%. Selectivity can be calculated on a mass basis, as in the example, or it can be calculated on a carbon basis, where the selectivity is calculated by dividing the amount of carbon that is found in a particular product by the amount of carbon that is found in a selection of products. Unless specified otherwise, for reactions involving polymers as reactants, selectivity is on a mass basis. For reactions involving conversion of a specific molecular reactant (ethene, for example), selectivity is the percentage (on a mass basis unless specified otherwise) of a selected product divided by all the products produced.

Yield—The term yield is used herein to refer to the amount of a product flowing out of a reactor divided by the amount of reactant flowing into the reactor, usually expressed as a percentage or fraction. Yields are often calculated on a mass basis, carbon basis, or on the basis of a particular feed component. Mass yield is the mass of a particular product divided by the weight of feed used to prepare that product. For example, if 500 grams of polymer is fed to a reactor and 45 grams of benzene is produced, the mass yield of benzene would be 45/500=9% benzene. Carbon yield is the mass of carbon found in a particular product divided by the mass of carbon in the feed to the reactor. For example, if 500 grams of polymer that contains 90% carbon is reacted to produce 400 grams of benzene that contains 92.3% carbon, the carbon yield in benzene is [(400*0.923)/(500*0.90)]=82.0%.

As is standard patent terminology, the term “comprising” means “including” and does not exclude additional components. Any of the inventive aspects described in conjunction with the term “comprising” also include narrower embodiments in which the term “comprising” is replaced by the narrower terms “consisting essentially of” or “consisting of”. As used in this specification, the terms “include”, “includes” or “including” should not be read as limiting the invention but, rather, listing exemplary components.

### DETAILED DESCRIPTION

For temperature-sensitive materials that are available as particulate solids, particularly plastics or biomass, several seconds of time at reactor temperature are required to permit melting of the material before it can sufficiently mix with the catalyst, pyrolyze, and the thermal pyrolysis products can react with the catalyst. Operating the catalytic reactor as an upflow transport reactor is ineffective because the residence times are typically less than 5 seconds in risers of reasonable heights (<20 meters), and operating at velocities greater than 4 m/s as required for the riser will prohibit the feeding of typical sized plastic particles (<1 mm diameter) from the top since their minimum fluidization velocity of <1 m/s will cause them to ‘float’ on top of the column, minimizing mixing and contact with the catalyst. Feeding polymer particles from the bottom of an upflow reactor is unsuitable since as the melting polymer coats the catalyst the particles will collide, agglomerate, and grow such that the system suffers ‘defluidization’, as described in “Defluidization Phenomena During the Pyrolysis of Two Plastic Wastes,” Arena, U., and M. L. Mastellone, Chem. Eng. Sci., 55, 2849, 2000.

Achieving fluidization velocities in an upflow riser catalytic reactor requires a large volume of lift gases that must be heated to process conditions, requiring considerable energy and cost. Similarly, operating an upflow reactor at lower superficial gas velocities, will require a lift line or jet to transport and introduce the plastic and catalyst into the reactor for sufficient mixing, which will also increase the risk of defluidization. Pre-mixing catalyst with polymer to feed the process is problematic because it requires handling and metering a highly viscous molten slurry that increases the risk of plugging; adding a mixing vessel does not overcome this problem because it is expensive and the fluidization velocity required for such premixed catalyst and polymer is much higher than for the catalyst alone, also adding costs and diluting the process stream. Moreover, most of the catalyst added to a fluidized bed is a hot, regenerated catalyst that will interact with the polymer in any mixing zone.

A bubbling bed reactor is preferred over an upflow riser (transport) reactor since the fluidization velocities in the bubbling bed are lower and the residence times are longer. Bubbling bed reactors also face challenges with the feed of low-density, thermally sensitive hydrocarbonaceous materials, particularly plastics. Feeding plastics into a bubbling bed reactor from below or from the side results in agglomeration of the plastic particles as they melt and stick together.

The present disclosure describes a process for producing useful chemicals or fuels by feeding relatively larger particles from above to a bubbling fluidized bed of catalyst and recovering olefins, aromatics, or both, and reaction systems for the process.

The present disclosure describes a process for producing useful chemicals or fuels comprising: feeding solid hydrocarbonaceous materials into a fluidized bed catalytic pyrolysis reactor containing a solid conversion catalyst by means of a particle distribution device that spreads feed particles over the surface of the bed; reacting the hydrocarbonaceous materials to form vapor products; withdrawing and recovering the vapor; and recovering olefins, aromatics, or both olefins and aromatics from the vapor products.

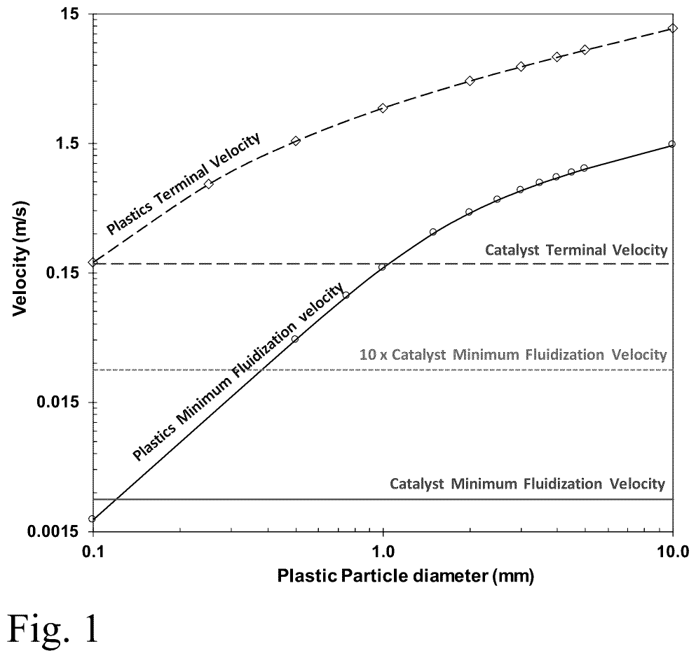

In order to overcome the problems with bottom and side feeding of temperature-sensitive materials such as plastics and biomass, and to permit the feeding of larger particles, the higher terminal velocity of larger particles (>1 mm) can be exploited. For particles that are dropped on the top of a bubbling bed to penetrate into the bed and avoid floating on the surface of the bed, the downward velocity of the particles must be greater than the fluidization velocity of the bed in the opposite (upward) direction. The terminal falling velocity of spherical plastic particles >1 mm in diameter is greater than the superficial gas velocity range in the bubbling bed reactor at 4 bara pressure, as shown in FIG. 1. At 4 bar pressure, a falling 1 mm plastic particle has a terminal velocity of ˜1.5 m/s, which is much larger than the maximum gas velocity expected in the pyrolysis reactor of 0.5 m/s. Therefore, a plastic particle fed from the top of the reactor will sink into the fluidized catalyst bed, allowing the plastic to react with the catalyst for a suitable time. This behavior becomes more prominent when feeding larger particles, e.g. >3.5 mm, which allows for the use of larger particles that require lower energy to process.

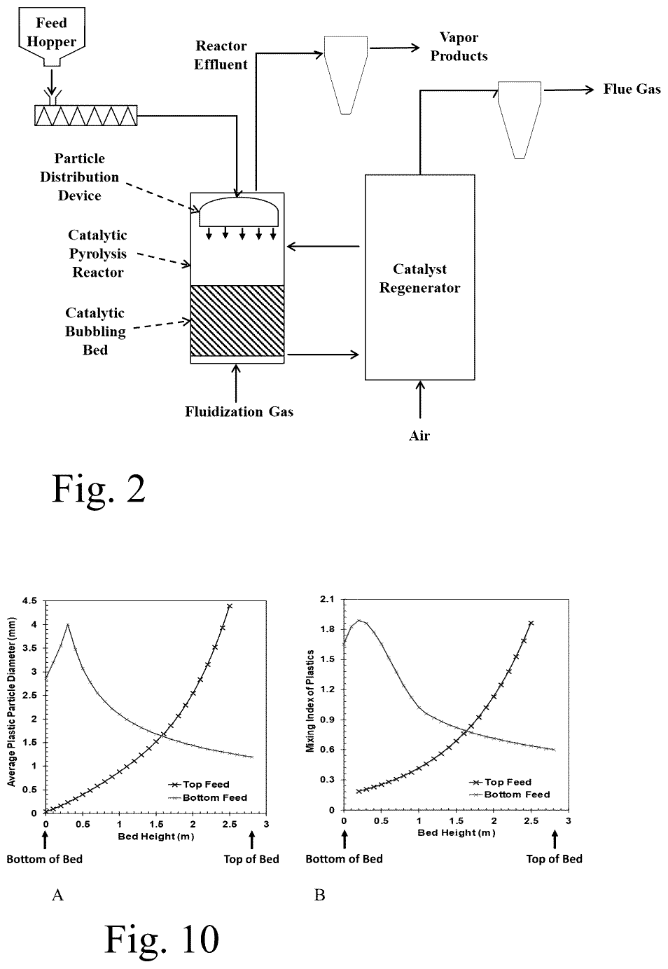

FIG. 2 presents a schematic of one embodiment of the process of the present invention in which solid hydrocarbonaceous feed is introduced from a feed hopper via a screw auger or other mechanical or pneumatic means into a particle distribution device that spreads the feed particles over the surface of the bubbling catalyst bed, i.e., overbed feeding. Catalytic pyrolysis is conducted in the reactor, entrained solids are separated from the reactor vapor effluent in one or more cyclones, and valuable products are recovered from the vapor. Catalyst is removed from the reactor and sent to a catalyst regenerator along with an oxidant (shown in FIG. 2 as Air) where catalyst is regenerated to remove coke, char, and carbonaceous deposits on the catalyst. The hot, regenerated catalyst is separated from the flue gas in one or more cyclones, and at least a portion of the hot, regenerated catalyst is returned to the bubbling bed reactor.

A feed mixture of plastics and other hydrocarbonaceous materials is supplied to a fluidized bed catalytic pyrolysis reactor where it is reacted to form a vapor product stream and a solid catalyst containing stream. The feed mixture is fed to the fluidized bed reactor from above (with respect to gravity) as shown in FIG. 2. In some embodiments the feed may be fed as particles. In some embodiments, where the feed comprises plastics, the feed mixture may be melted to form a molten liquid that is extruded and the extrudate is chopped to an appropriate size range to be fed to the reactor.

Catalyst fed to the fluidized bed reactor comprises a portion of the regenerated catalyst and may comprise fresh catalyst. Typically, as the catalyst activity decays, a small portion of catalyst is replaced regularly with fresh catalyst, preferably at a rate of about 1-3% per day or less. Additional fresh catalyst may be added to the system via a makeup stream. Fresh catalyst may be added to the catalytic pyrolysis reactor with the regenerated catalyst, may be added separately, may be added with the feed materials, or any combination of these.

In the fluidized bed reactor, the hydrocarbonaceous materials are pyrolyzed and catalytically converted to a vapor stream containing useful products including olefins, paraffins, and aromatics, and which carries along entrained solid catalyst and other solids. The vapor products are separated from the entrained solids in one or more cyclones. At least a portion of the solid particles can be returned to the catalytic reactor, a portion of the solids may be removed, and a portion of the solids may be fed to the catalyst regenerator. The vapor products can be sent to a separation and recovery system to recover useful products, such as paraffins, olefins, aromatics, or other products. Waste plastics often contain small particles of fillers to enhance processing and reduce costs. During the catalytic pyrolysis process catalyst particles undergo some attrition to produce small particles as well. During the separation of solids from the product gases in the cyclone(s), the catalyst can be at least partially separated from the smaller particles provided the catalyst particle size distribution of the fresh catalyst contains only minor amounts of small particles. Thus, preferably the catalyst particle size distribution of fresh catalyst comprises at least 60, 75, 80, 90, 95, 97, 98, 99, or 99.8, or from 80 to 99.8, 90 to 99.8, or 95 to 99.8% by mass particles of at least 50, 60, 70, or 80 μm in diameter.

A catalyst-containing stream is removed from the catalytic reactor and passed to a catalyst regenerator in which it is contacted with an oxidizing gas such as air to regenerate the catalyst and produce energy from the combustion of the organics. Catalyst can be removed from the catalytic pyrolysis reactor via an overflow standpipe, a drainpipe, or another apparatus, as is commonly practiced with fluid bed reactor systems.

The vapor product stream from the catalytic pyrolysis is separated into valuable product streams containing olefins and aromatics, and a byproduct stream that may contain methane, ethane, propane, butane, H2, CO2, and CO. Optionally, a portion of the byproduct gas stream can be passed to the regenerator to increase the heat generation therein or used in the fluidization of the catalytic reactor. Energy for use in the process, e.g., for heating feed materials or recycle or fluidization gases or for other purposes, may be recovered from the hot combustion gases (flue gas) produced in the regenerator by heat exchange in one or more heat exchangers, or by other means. A portion of the energy generated in the catalyst regenerator can be used as thermal energy in the catalytic pyrolysis reactor, or for feed preparation, or for product separation, or a combination of these, or the energy can be converted to electrical energy, or the generated energy can be used as thermal energy and electrical energy within the plant or exported. At least a portion of the hot regenerated catalyst is returned to the catalytic pyrolysis reactor to supply heat to drive the catalytic pyrolysis process. In one set of embodiments, an oxidizing agent is fed to the riser regenerator via a gas feed stream shown as ‘Air’ in FIG. 2. A solid mixture comprising partially deactivated catalyst may comprise residual carbon and/or coke as well as coke or char from the process, which may be removed via reaction with the oxidizing agent in the regenerator. The oxidizing agent may originate from any source including, for example, a source of oxygen, atmospheric air, or steam, among others. In the regenerator, the catalyst is re-activated by reacting the catalyst with the oxidizing agent, and heat is generated.

In some embodiments, a portion of the gaseous products from the catalytic pyrolysis process is fed to the catalyst regenerator to be combusted with the solid materials. In other embodiments, natural gas or other light hydrocarbons or droplets of liquid hydrocarbonaceous materials or small particles of solid hydrocarbonaceous materials or some combination of these may be fed to the catalyst regenerator, which combustion provides additional heat to the regenerator. The regenerator in FIG. 2 comprises a flue gas vent stream which may include regeneration reaction products, residual oxidizing agent, residual hydrocarbons, etc. As shown in the illustrative embodiment of FIG. 2, the regenerated catalyst may exit the regenerator, be separated from the vapors in one or more cyclones, and at least a portion of the regenerated catalyst is recycled back to the catalytic pyrolysis reactor via a recycle stream. In some cases, catalyst may be lost from the system during operation and replaced by fresh catalyst. In some cases, additional fresh catalyst may be added to the system via a makeup stream.

In some embodiments, the catalytic pyrolysis reactor is operated at temperatures from 400 to 700, from 450 to 650, or from 500 to 600, or at least 400, at least 450, or at least 500, or no more than 700, no more than 650, or no more than 600° C. In some embodiments, the residence time of the feed materials in the catalytic pyrolysis reactor is from 1 to 30, from 2 to 20, or from 5 to 15, or at least 1, at least 2, or at least 5, or no more than 30, no more than 20 or no more than 15 minutes. In some embodiments, the pressure in the thermal pyrolysis reactor can be from 1 to 30, from 2 to 20, or from 3 to 10, or at least 2, at least 3 or at least 4, or no more than 30, no more than 20 or no more than 10 barg.

In some embodiments of the process, olefins are separated from the catalytic pyrolysis products for upgrading to BTX or other valuable products, and at least a portion of the olefins are recycled to the catalytic pyrolysis reactor. This configuration of the inventive process takes advantage of the capability of the catalytic process to convert olefins to aromatics, boosting the yield of aromatics obtained from the process, and improving the efficiency of the overall process. In this embodiment, the number of unit operations is minimized, and the capital investment is reduced compared to some other embodiments of the process, and this embodiment may be more applicable to stand-alone plants where opportunities for integration with nearby processes are not available.

The various features, characteristics, embodiments, etc. that are described herein are not limited to a single aspect or embodiment and should be understood as applicable to any of the inventive aspects described herein.

Polymers or plastics or polymers and plastics are fed to a catalytic pyrolysis reactor to form a gaseous product containing aromatic compounds and olefins, wherein the olefins are separated from the product, the olefins are purified and separated into the various component olefins, and each olefin stream is sent for further processing for conversion to useful products or recycled to the catalytic pyrolysis reactor.

The mixed polymer feed to the process may comprise one or any combination selected from the following materials: biomass, polyethylene (PE), polypropylene (PP), polyacetylene, polybutylene, polyolefins, polyethylene terephthalate (PET), polybutylene terephthalate, copolyesters, polyester, polycarbonate, polyurethanes, polyamides, polystyrene (PS), polyacetal, epoxies, polycyanurates, polyacrylics, polyurea, vinyl esters, polyacrylonitrile, polyvinyl alcohol, polyvinylchloride (PVC), poly(methyl methacrylate) (PMMA), polyvinyl acetate, nylon, copolymers such as: ethylene-propylene, EPDM, acrylonitrile-butadiene-styrene (ABS), nitrile rubber, natural and synthetic rubber, tires, styrene-butadiene, styrene-acrylonitrile, styrene-isoprene, styrene-maleic anhydride, ethylene-vinyl acetate, nylon 12/6/66, filled polymers, polymer composites, polymer composites comprising natural fibers, plastic alloys, other polymeric materials, and polymers or plastics dissolved in a solvent. The feed materials can comprise materials obtained from polymer or plastic manufacturing processes as waste or discarded materials, post-consumer recycled polymer materials, materials separated from waste streams such as municipal solid waste (MSW), black liquor, wood waste, or other biologically produced materials.

In some embodiments, the feed material can comprise from 30 to 100, from 40 to 80, or from 45 to 70, or at least 30, at least 40, or at least 45, or less than 99, less than 95, or less than 80 percent by mass of a combination of polyethylene (PE) (sum of low- and high-density polyethylene), polypropylene (PP), and polystyrene (PS). In some embodiments, the feed material can comprise from 1 to 30, 2 to 20, or 3 to 10, or up to 30, up to 20 or up to 10, or at least 0.1, or at least 1, or at least 2 percent by mass biomass. In some embodiments the feed can comprise from 0.1 to 20, from 1 to 15, or from 3 to 10, or at least 0.1, at least 1, or at least 3, or less than 20, less than 15, or less than 10 percent by mass PET. In some embodiments the feed can comprise from 0.1 to 20, from 1 to 15, or from 3 to 10, or at least 0.1, at least 1, or at least 3, or less than 20, less than 15, or less than 10 percent by mass nylon.

In some embodiments the feed materials used in the process are pretreated at least in part to reduce contaminant concentrations in a contaminant removal process before addition to the catalytic pyrolysis process. A “contaminant” is a material such as silica or metal or metal oxide or salt or carbon black or clay or any other material that is commonly used as an additive in commercially available plastics or an element that may poison the catalyst or contribute to a reduction in catalyst activity, and that does not pyrolyze under typical pyrolysis conditions. Removal of contaminants from plastics can be accomplished by filtering off solids from a solution or melt, or in some preferred embodiments, by a first pyrolysis step, without added catalyst (or without zeolite catalyst). The contaminant removal process can include any of those such as washing with water or a solvent, and by those described in U.S. Pat. Nos. 10,336,628, 6,792,881, 7,303,649, 7,503,981, 8,101,024, 9,109,049, 9,468,950, and US Patent Application Publication US 2015/0166683, or any method known to those skilled in the art.

It may be advantageous to feed the polymers at least in part as molten material. This can be done with polymers or plastics alone or as mixtures of polymers and plastics that melt at temperatures below 200° ° C. The mixture of polymers, or plastics, or polymers and plastics may be melted and filtered to remove solids that do not readily melt at the chosen process conditions using any of the variety of filtering procedures known to those skilled in the art. In some embodiments in which the molten mixture of polymers, or plastics, or polymers and plastics, comprises materials that contain carbonaceous solids, these solids may be separated by hot filtration and optionally combusted to provide energy for the process.

### Particulate Distribution Devices

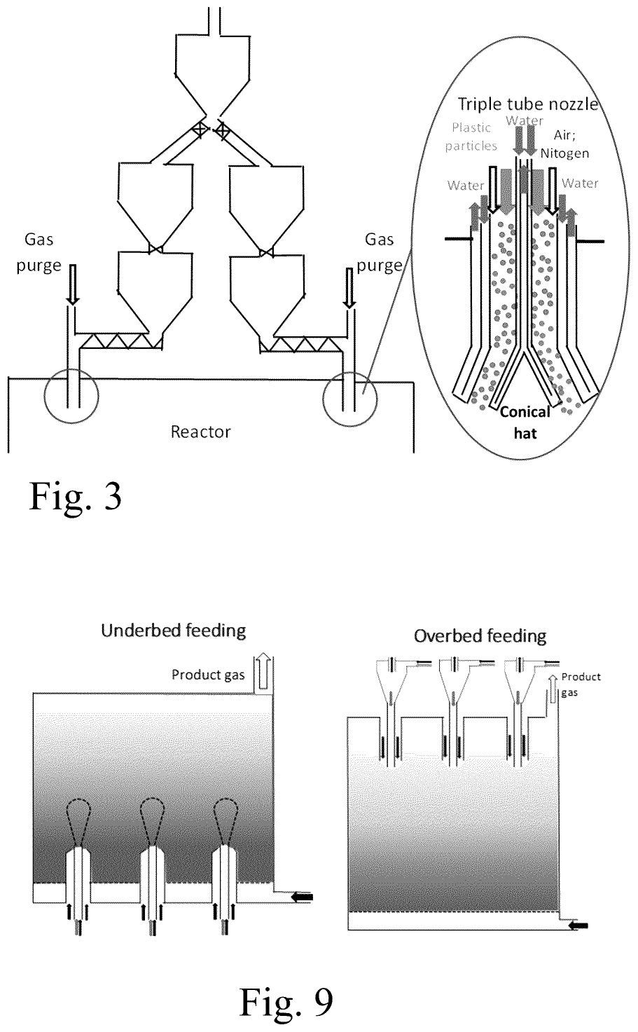

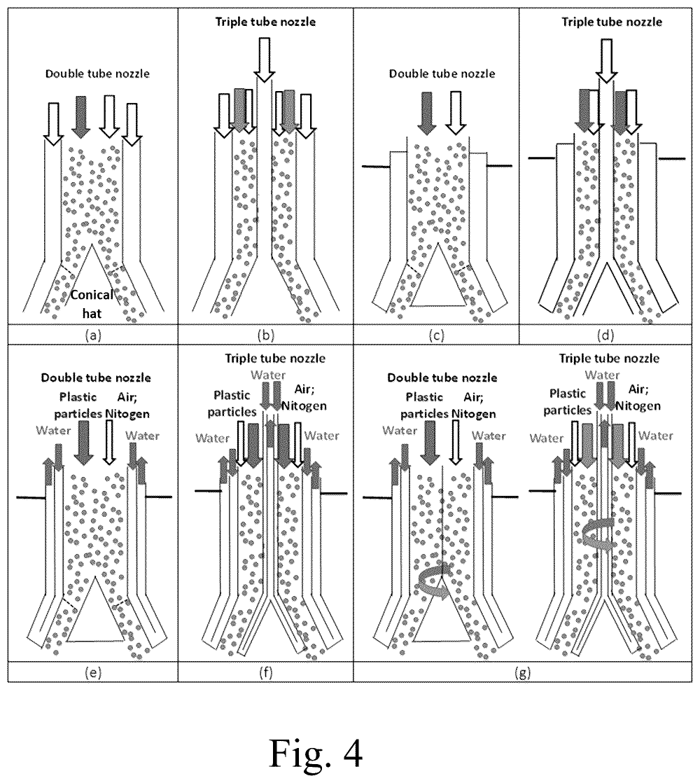

A variety of devices are suitable for distributing particulate matter to the top of fluidized beds. For example, one or more nozzles are used to distribute particulate feed over a fluidized bed. The general arrangement of nozzles used to feed plastic-containing feedstock into a fluidized bed pyrolysis reactor is shown in FIG. 3. The nozzles introduce the plastic-containing feed from the top of the reactor (overbed) using a lock hopper system connected to a screw feeder. The system may include one or more nozzles feeding directly to the reactor. The nozzles may have any of the arrangements depicted in FIG. 4, as described below.

In FIG. 4(a) a double tube nozzle is shown. The nozzle includes feed particles and carrier gas flowing through the central tube and cooling gas flowing through the annular (outer ring) tube. In the center tube there is a “Conical hat” in the center of the tube outlet that spreads out the stream of gas and particles. FIG. 4(b) shows a triple tube nozzle. In addition to the double tube nozzle shown in (a), a centrally arranged gas tube is included, but there is no separate conical hat. The outlet of the central tube has the conical shape of an umbrella to guide the plastic particles in the radial direction of the reactor. In FIG. 4(c), a stagnant gas (air or inert) in the outer (ring) tube is acting as a thermal barrier. Plastic particles and transport gas flow through the center tube. As above, in the center tube there is a “Conical hat” at the tube outlet that is fixed at the center tube. The hat does not extend beyond the end of the thermal barrier tube to ensure cooling. The gas flow in the center tube cools the entire nozzle. FIG. 4(d) presents a variation of the triple tube nozzle in which the nozzle uses a centrally arranged gas tube and a conical hat. The outer tube contains a stagnant gas that acts as the thermal barrier to keep the feed cool. The outlet of this tube has the shape of an umbrella to guide the plastic particles in the radial direction of the reactor. A water-cooled tube is the thermal barrier in FIG. 4(e). This is a variation on FIG. 4(c) in which the outer tube is actively cooled by flowing water. Plastic particles and interstitial gas are flowing through the center tube. There is a “Conical hat” at the tube outlet of the gas and particulate stream (fixed at the cooled tube). FIG. 4(f) shows a double tube nozzle that is a variant of FIG. 4(d) in which water cooling is used both for the outer tube and the inner tube. In addition to the double tube nozzle, a centrally arranged water-cooled tube is used to cool the “Conical hat”. The two nozzles in FIG. 4(g) are variants of FIGS. 4(c) and 4(f) wherein the conical hat is rotated during operation to enhance the distribution of the particles as they enter the reactor. During the rotation of the conical hat, the plastic particles are expelled in the radial direction, which supports the dispersion of the plastic particles.

Overbed vs. Underbed Feeding

Feed nozzle location is important for performance of the process. The particle injection nozzle must be cooled to keep the feed from melting before being released into the bed. In underbed feed designs, the nozzle is a heat sink, reducing the temperature of the bed in its immediate environs, so that the temperature of the feed heats slowly as it enters the bubbling bed. Also in underbed feed designs, the concentration of feed is quite high close to the tip of the nozzle which supports the building of agglomerates that can block the nozzle. In the overbed design, the nozzle is far from the bed so that it does not impact the local temperature distribution at the point where the feed enters the bed, allowing the feed to be heated rapidly.

In the underbed design, the plastic particles in the gas jet enter the bed with a low velocity which results in a poor distribution of particles along the gas jet due to the resistance of the catalyst particles. Increasing the gas jet velocity to provide better mixing in the underbed design would require a higher flow of carrier gas. As the carrier gas must be cool to prevent premature decomposition of the feed, the result is slower heating of the feed, increasing the tendency for agglomeration and reducing decomposition. A higher flow of carrier gas would increase costs and reduce product recovery efficiency.

Sidebed feed designs suffer from the same drawbacks as underbed feed designs. In the overbed design a very low carrier gas flow is required to introduce the feed into the reactor since the falling particles will reach terminal velocity that is sufficient to inject them into the bed. The calculated terminal velocity is 1.8 m/s for a 1 mm particle and 4.7 m/s for a 5 mm particle at 4 bar pressure, while the minimum fluidization velocity of the bubbling bed is only 0.5 m/s as shown in FIG. 1. This reduces costs and limits the dilution of the product stream.

The overbed feed design is thus preferred to underbed or sidebed feed systems for use with sticky or temperature sensitive feed materials such as plastics or biomass.

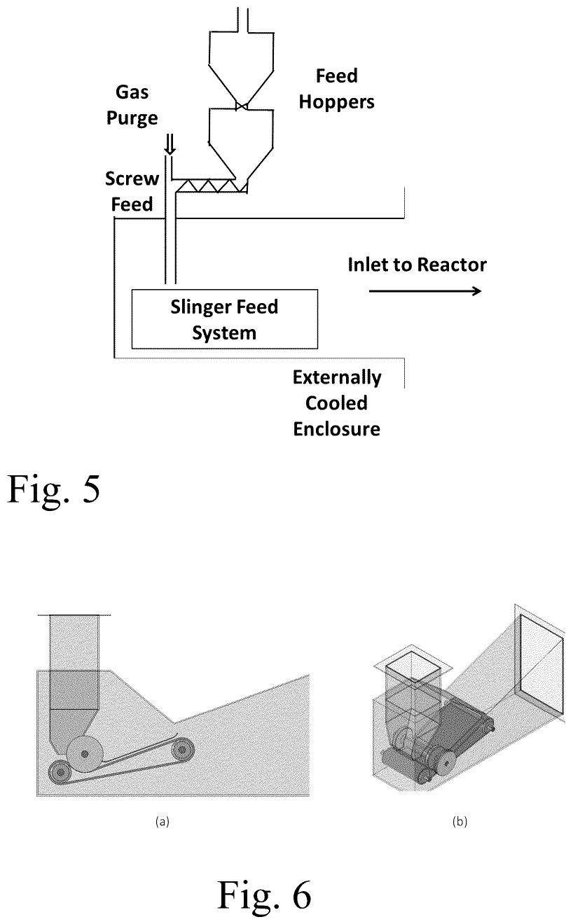

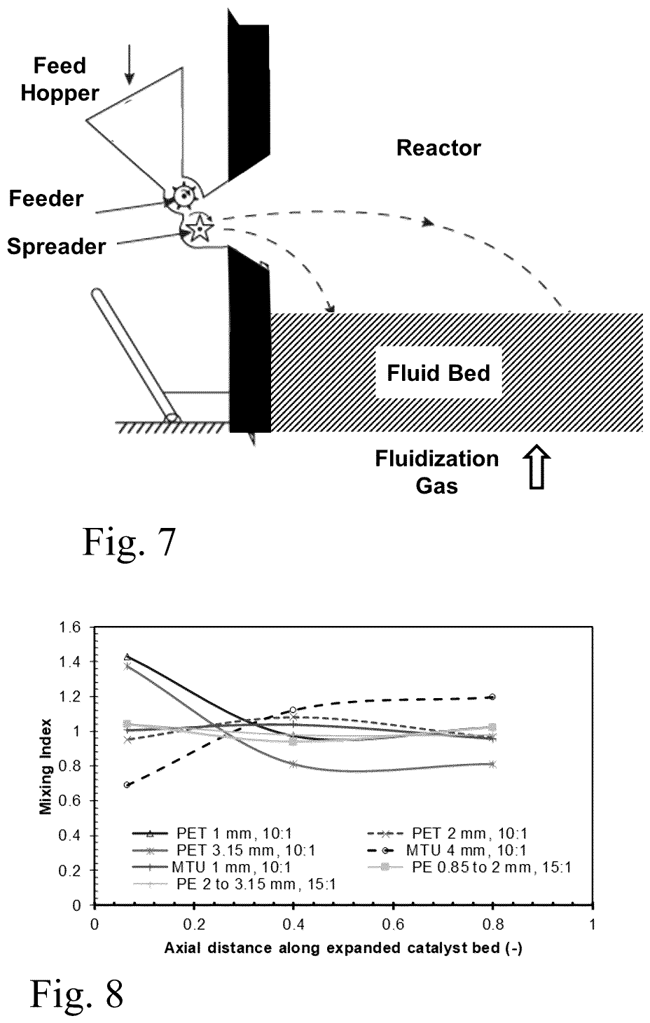

Another particle distribution device that is suitable for use in the process is the slinger feeder. The general arrangement of slinger feeders for feeding plastic-containing feedstock into the pyrolysis reactor is shown in FIG. 5. This type of feeding mechanism is mounted inside an enclosure to the side of the reactor. The enclosure is externally cooled to maintain the temperature inside the enclosure at temperatures below the softening temperature of the feedstock. The feedstock is introduced onto the slinger feeder using either a screw or rotary feeder fed from one or more feed storage hoppers. The slinger provides the feed particles with sufficient momentum to enter the reactor by propelling the particles into the top portion of the reactor above the catalyst bed. There are two primary types of slinger systems envisioned for the process, a slinger belt feeder (FIG. 6) and a slinger wheel feeder (FIG. 7).

A conceptual view of a slinger belt feeding arrangement is shown in FIG. 6. As can be seen, the belt may be angled to optimize the throwing trajectory of the plastic particles; a steeper angle will throw the feed further, although there is a limit, beyond which, the feed is not thrown as far. Unlike other commercially available slinger belts, the slinger feeder in this invention does not employ a conventional rubber belt, instead, the belt consists of 2 chains fitted with pushers, protrusions from the chain held between the chains that minimize slippage of the plastic particles along the belt and serve to propel the feed. The pushers allow for enhanced distribution of the particles into the bed and provide better control of the radial distribution pattern of the particles being fed into the bed by using different pusher patterns or combinations of such designs chosen for the particles being fed and the geometry of the reactor.

A slinger wheel type distributor (FIG. 7) operates using the same principle and design approach as the slinger belt. The spreader wheel consists of a cylinder with pushers protruding from the cylinder to propel the feed into the reactor and control the distribution of the feed as it is fed to the top of the catalyst bed. The rotational speed of the wheel can be adjusted to send the feed to different distances, although there is typically a range over which the particles are distributed. An alternative slinger wheel is situated with a vertical axis, much like a broadcast spreader used to spread seed. Due to the small volume, the slinger wheel will require less cooling compared to the slinger belt and may also be more suited for smaller commercial scale plants, which will have smaller diameter catalytic pyrolysis reactors.

### Catalytic Pyrolysis Reactor

The catalytic pyrolysis reactor comprises a fluidized bed reactor, such as a bubbling bed or turbulent bed reactor. Fluidized bed reactors may, in some cases, provide improved mixing of the catalyst and/or polymeric material during pyrolysis and/or subsequent reactions, which may lead to enhanced control over the reaction products formed. The use of fluidized bed reactors may also lead to improved heat transfer within the reactor. In addition, improved mixing in a fluidized bed reactor may lead to a reduction of the amount of coke adhered to the catalyst, resulting in reduced deactivation of the catalyst in some cases and higher yields of olefins or aromatics or other desirable products. Throughout this specification, various compositions are referred to as process streams; however, it should be understood that the processes could also be conducted in batch mode. The catalytic pyrolysis reactor is a fluidized bed reactor; and the catalyst traverses the reactor in a downwards direction such that the regenerated and any fresh catalyst fed to the reactor enters nearer the top of the reactor, and catalyst exits the reactor nearer the bottom of the reactor. The fresh catalyst may be fed with the regenerated catalyst or from a separate conduit or some combination of these. The reactor comprises a sparger or distributor, located at or near the bottom of the reactor which serves to distribute the fluidization fluid. The fluid bed is fluidized with a fluidization fluid such as an inert gas, or a hydrocarbon gas, or a recycle stream separated from the products, or some combination of these, at a velocity and density sufficient to induce operation in the bubbling or turbulent flow regime in the catalyst bed, as described in “Fluidization Engineering”, D. Kunii and O. Levenspiel, 2nd Ed. Butterworth-Heinemann, 1991, pp 1-236. The catalytic pyrolysis reactor operates in either the bubbling or turbulent fluidization regimes, or a combination of both due to axial increase in gas velocity resulting from gas generation from the thermal pyrolysis of feed materials. The inlet gas velocity of the fluidization fluid entering the reactor can range from 0.05 to 1.0, or from 0.1 to 0.7, or from 0.2 to 0.5, or at least 0.1, or at least 0.2, or at least 0.3, or less than 1.0, or less than 0.7, or less than 0.5 meters per second.

The residence time of the feed material within the reactor is an important feature that impacts the performance of the system, the conversion of the feed, and the selectivity to different products. For the catalytic pyrolysis process of this invention the residence time of an average carbon atom (meaning averaged over all carbon entering the reactor) of the solid hydrocarbonaceous materials within the catalytic pyrolysis reactor can range from 5 to 180, or from 10 to 100, or from 15 to 80, or from 20 to 60, or from 25 to 60, or at least 5, or at least 10, or at least 30, or less than 180, or less than 100, or less than 80, or less than 60 seconds. The residence time is calculated as the average time a carbon atom spends in the reactor at a temperature of at least 400° C. under actual conditions of temperature and pressure.

The weight hourly space velocity is another factor that greatly impacts the performance of the process by affecting the yield and selectivity of various valuable products and the operability of the system. The weight hourly space velocity is defined as the mass rate of feed of solid hydrocarbonaceous materials (\dot{m}) divided by the mass of catalyst in the reactor bed:

$$WHSV ( 1 / hr ) = \frac{{\dot{m}}_{feed} ( kg / hr )}{Mass of catalyst in bed ( kg )}$$

In some embodiments of the inventive process the WHSV can range from 0.1 to 2.0, or from 0.2 to 1.0, or from 0.25 to 0.75, or at least 0.1, or at least 0.2, or at least 0.25, or less than 2.0, or less than 1.0, or less than 0.75 hr-1.

The catalytic pyrolysis reactor can be any size suitable for conversion of solid materials to higher value products. In some embodiments the capacity of the reactor will be suitable for processing 5 to 5000 metric tons per day (mtpd) of feed, or from 5 to 2500 mtpd, or 100 to 1500 mtpd, or at least 25 mtpd, or at least 100 mtpd of feed materials. The diameter of the catalytic pyrolysis reactor can range from 0.1 to 15, or from 0.3 to 10, or from 3 to 7, or at least 3, or at least 5 meters as required to meet the demands of the rate of introduction of feed materials; the required diameter increases as approximately the square root of the increase in capacity of the reactor. The catalytic pyrolysis reactor is characterized by a height/diameter ratio (H:D) that can be from 0.5:1 to 10:1, or from 1:1 to 8:1, or from 1.5:1 to 5:1, or at least 1:1, or at least 1.5:1, or at least 2:1, or less than 15:1, or less than 10:1, or less than 5:1. In some cases, the reactor has a uniform internal diameter. In cases where the diameter is not uniform, “diameter” refers to the diameter averaged over the height of the reactor.

The temperature of the catalytic pyrolysis reactor can be maintained at a temperature that is high enough to provide high conversion of the feed materials and yet low enough to not produce a very high yield of coke and char. The temperature for the catalytic pyrolysis reactor can be from 450 to 750, or from 500 to 650, or from 550 to 600, or at least 450, or at least 500 or at least 550, or no more than 750, or no more than 650° C. Heat is supplied to the catalytic pyrolysis reactor by the feed of hot, regenerated catalyst to the reactor. The mass flow rate of the hot, regenerated catalyst recycle stream is adjusted to provide enough heat to maintain the reactor temperature and drive the thermal pyrolysis reaction. The mass flow rate of the hot, regenerated catalyst recycle stream can be from 3 to 1700, or from 170 to 845, or at least 60, or at least 150 or at least 310, or less than 170, or less than 360 or less than 845 kg/s, as required to meet the heat demands of the reactor. Alternatively, the mass flow rate of the hot regenerated catalyst into the catalytic pyrolysis reactor, when defined as the percent of catalyst added per unit time divided by the amount of catalyst in the bed, can be from 0.025% per second to 5% per second, or from 0.1% per second to 3.5% per second, or at least 0.5% per second, or at least 1.5% per second, or at least 3% per second, or less than 7% per second, as required to meet the heat demands of the reactor. Additional heat may be provided from other sources to maintain the desired temperature of the process if needed.

A portion of the regenerated catalyst can be removed from the separated stream of regenerated catalyst and discarded. In some embodiments the amount of catalyst that is removed and discarded can be from 0.1 to 5.0, from 0.5 to 4.0, or from 1.0 to 3.0, or at least 0.1, at least 0.5, or at least 1, or no more than 5.0, no more than 4.0 or no more than 3.0% by mass of the regenerated catalyst each day. Fresh catalyst may be fed to the catalytic pyrolysis reactor with the regenerated catalyst or from a separate conduit or some combination of these. Preferably, the amount of fresh catalyst added to the catalytic pyrolysis reactor can be from 0.1 to 5.0, or from 0.5 to 4.0, or from 1.0 to 3.0, or at least 0.1, or at least 0.5, or at least 1, or no more than 5.0, or no more than 4.0 or no more than 3.0% by mass of the regenerated catalyst each day. The pressure of the catalytic pyrolysis process can be maintained at a pressure that is high enough to provide sufficient driving force to move the materials through the apparatus, and yet low enough to maintain good fluidization, minimize compression costs, and allow for facile feed of feed materials and catalyst. Suitable pressures are from 0.5 to 10, or 1.0 to 6, or 1.5 to 4, or at least 1, or at least 1.5 or at least 2, or less than 20, or less than 10, or less than 6 barg.

A pyrolysis reactor with a larger diameter at higher levels has the advantage of having a more uniform gas velocity along the height of the reactor which increases BTX and olefins yield and reactor productivity compared to a cylindrical shaped reactor in which gas velocity increases along the height of the reactor. Reactor performance is improved by decreasing the velocity gradient along the reactor. To overcome this deficiency and provide for a more uniform linear velocity of the feed materials and catalyst as the gas passes upwards through the fluid bed, the diameter of the reactor can increase along the height of the reactor. A conical geometry with an expanding diameter along the height of the reactor to accommodate the higher gas generation provides better performance. In some embodiments the diameter of the catalytic pyrolysis reactor increases along at least a portion of the height of the reactor. In these embodiments the diameter of the portion of the reactor that increases is smaller nearer the bottom of the reactor and larger nearer the top of the reactor. The variable diameter of at least a portion of the reactor can be shaped like a cone where the angle of the wall of the cone with respect to vertical can range from 3 degrees to 50 degrees, or from 5 to 40, or from 7 to 25, or from 8 to 15, or at least 3, or at least 7, or at least 8 degrees, or at least 10 degrees from vertical (vertical is defined as zero degrees). In some embodiments the ratio of the superficial velocity of the vapors at the top of the conical portion of the reactor is no more than 1.01:1, or no more than 1.5:1, or no more than 2.0:1, or no more than 2.5:1, or no more than 3.0:1, or from 1.01:1 to 3.0:1, or from 1.1:1 to 2.0:1 compared to the superficial velocity of the vapors at the bottom of the conical portion of the reactor. The conical portion of the reactor should include at least the height of the dense bubbling phase of the fluid bed. Any additional height of the reactor above the top of the fluid bed, the so-called ‘freeboard,’ can be cylindrical as very little reaction occurs in this zone so the gas expansion is negligible.

Catalyst may be removed from the catalytic pyrolysis reactor via a solids exit conduit such as an overflow standpipe or drainpipe or other means. In some cases, the catalyst removed from the catalytic pyrolysis reactor may be at least partially deactivated. The catalyst removed from the catalytic pyrolysis reactor may be fed to a regenerator in which catalyst that was at least partially deactivated may be reactivated. The regenerator may comprise an optional purge stream, which may be used to purge solids such as coke, ash, catalyst, or some combination of these, from the regenerator. The catalyst regenerator may be of any suitable size mentioned above in connection with the reactor or the solids separator. In addition, the regenerator may be operated at elevated temperatures e.g., at least 300, 400, 500, 600, 750, 800, or higher, or from 500 to 1000, or from 600 to 800, or from 650 to 750° C. The residence time of the catalyst in the regenerator may also be controlled using methods known by those skilled in the art, including those outlined above. The residence time of the catalyst in the regenerator can be from 25 to 500, or from 50 to 300, or from 75 to 150, or at least 25, or at least 50, or at least 75, or at least 100, or no more than 500, or no more than 300 or no more than 150 seconds. The mass flow rate of the catalyst through the regenerator may be coupled to the flow rate(s) in the reactor and/or solids separator to preserve the mass balance in the system.

An oxidizing agent can be fed to the regenerator via a gas feed stream. The oxidizing agent may originate from any source including, for example, a source of oxygen, air, recycled flue gas, or steam, or some combination of these, among others. The regenerator comprises a sparger or distributor, located at or near the bottom of the regenerator, that serves to distribute the fluidization fluid. The fluid bed is fluidized with a fluidization fluid such as air, or oxygen in nitrogen, or flue gas, or steam, or some combination of these, at a velocity and density sufficient to induce operation in the fast fluidization regime in the regenerator bed, and pneumatic transport of the catalyst to the top of the bed, as described in “Fluidization Engineering”, D. Kunii and O. Levenspiel, 2nd Ed. Butterworth-Heinemann, 1991, pp 73-94 and pp 359-396. In some embodiments the superficial fluidization gas velocity at the entrance of the regenerator can be at least 1.5, or at least 2.0, or at least 2.5, or at least 3.0, or from 0.6 to 7.5, or from 1.0 to 6.0, or from 1.5 to 5.0, or from 2.5 to 4.5, or from 3.0 to 4.0, or no more than 7.5, or no more than 6.5, or no more than 5.0, or no more than 4.0 m/s. In some embodiments the height to diameter ratio (H/D) of the regenerator can be from 2 to 15, or from 3 to 22, or from 5 to 40, or from 10 to 44, or at least 2, or at least 5, or at least 10, or no more than 10, or no more than 15, or no more than 30, or no more than 44.

In the regenerator, the catalyst is re-activated by reacting the catalyst with the oxidizing agent. In some cases, the deactivated catalyst may comprise residual carbon and/or coke, which may be removed via reaction with the oxidizing agent in the regenerator. The regenerator comprises a vent stream which may include regeneration reaction products, residual oxidizing agent, etc. The exhaust gas vent stream from the regenerator may be passed through a catalytic exhaust gas cleanup system to further reduce the concentrations of CO and hydrocarbons to reduce emissions vented to the atmosphere. Portions of the exhaust gas vent stream may be recycled to the gas feed of the regenerator to control the heat release of the regeneration process. A separated stream of gases comprising gases chosen from among any of C1-C4 hydrocarbons, H2, and CO can be separated from the vapor products and at least a portion of the separated stream of gases is passed to the regenerator as part of the fluidization fluid.

The regeneration may be operated with fluidization flow rates suitable to maintain continuous transport of the catalyst through the regenerator. The flow velocity of the gas mixture within the regenerator is affected by many parameters including: the mass flow of catalyst, the size and density of catalyst particles, the amount of coke and char and other materials that will be combusted in the regenerator, the feed mixture to the catalyst pyrolysis unit, the system pressure, and the temperature profile of the unit. The solids flux, which is the rate of mass flow of solid material through a cross sectional area of the regenerator, is in the range from 19 to 300, or 50 to 250, or 100 to 200, or at least 19 or at least 50, or at least 100, or at least 150, or no more than 300, or no more than 250, or no more than 200 kg/m²s.

The reaction products from the catalytic pyrolysis reactor (e.g., fluid hydrocarbon products) may be fed to a solids separator such as one or more cyclones where solid catalyst may be separated from the fluid products. In some instances, the initial products of the process may be fed to a quench tower to which is fed a cooling fluid, preferably a liquid, along with the product stream to cool and condense the products. In some embodiments, the desired reaction product(s) (e.g., liquid aromatic hydrocarbons, olefin hydrocarbons, gaseous products, etc.) may be recovered at any point in the production process (e.g., after passage through the reactor, after separation, after condensation, etc.). The reaction products may be quenched to remove heavy hydrocarbons into a quench fluid. The quench fluid may comprise liquid products recovered in subsequent separation steps. The gaseous stream from the quench can be sent to a fractionation tower where the various aromatic liquid components can be recovered. The gaseous stream from the top of the fractionation tower can be sent to an absorption tower where the final fraction of remaining liquid organic is recovered. This can be done using a lean oil fraction as the absorption fluid which can comprise liquid product recovered from the fractionation tower or other available liquid known to those skilled in the art. A portion of the gaseous stream, now stripped of most higher boiling products, may be sent back to the reactor as fluidization fluid or for further conversion. The balance of the gaseous stream can be sent to a product recovery system for purification of the olefins. The recovered olefins can be sent to any of a variety of upgrading processes to convert them to other products.

The molecular sieve for use herein or the catalyst composition comprising same may be thermally treated at high temperatures. This thermal treatment is generally performed by heating at a temperature of at least 370° C. for a least 1 minute and generally not longer than 20 hours (typically in an oxygen containing atmosphere, preferably air). While subatmospheric pressure can be employed for the thermal treatment, atmospheric pressure is desired for reasons of convenience. The thermal treatment can be performed at a temperature up to 925° C. The thermally treated product is particularly useful in the present process.

For the catalyst composition useful in the catalytic pyrolysis of this invention, the suitable molecular sieve may be employed in combination with a support or binder material such as, for example, a porous inorganic oxide support or a clay binder. Non-limiting examples of such binder materials include alumina, zirconia, silica, magnesia, thoria, titania, boria and combinations thereof, generally in the form of dried inorganic oxide gels and gelatinous precipitates. Suitable clay materials include, by way of example, bentonite, kieselguhr and combinations thereof. The relative proportion of suitable crystalline molecular sieve of the total catalyst composition may vary widely with the molecular sieve content ranging from 30 to 90 percent by weight and more usually in the range of 40 to 70 percent by weight of the composition. The catalyst composition may be in the form of an extrudate, beads or fluidizable microspheres.

The molecular sieve for use herein or the catalyst composition comprising it may have original cations replaced, in accordance with techniques well known in the art, at least in part, by ion exchange with hydrogen or hydrogen precursor cations and/or metal ions of Group VIII of the Periodic Table, i.e., nickel, iron and/or cobalt, rhodium, ruthenium, palladium, iridium, or platinum, or some combination thereof, or gallium.

The volatile product stream from the catalytic pyrolysis reactor (the raw feed from the catalytic pyrolysis reactor, prior to purification) can comprise C2-C4 alkenes, including ethylene, propylene, butylenes, or butadiene, or combinations thereof. The vapor products from the catalytic pyrolysis can comprise from 1-70 wt %, 5-65 wt %, 10-60 wt %, 20-50 wt %, 30-45 wt %, 40-65 wt %, or 50-70 wt %, or at least 20 wt %, at least 30 wt %, at least 40 wt %, at least 50 wt %, or at least 60 wt % C2-C4 alkenes. In some embodiments a stream enriched in ethylene or propylene, or both is separated from the condensable higher materials in the vapor products. The mass ratio of ethylene to propylene can vary from 0.2 to 3 depending on reaction conditions and feedstock. The mass ratio of butenes to propylene can vary between 0.05 and 0.62. Other minor components such as C5-C7 olefins are present in much smaller mass ratios to propylene and the mass ratio can vary in the range of 0.05 to 0.25.

In broader aspects of the invention, the olefin-containing product stream separated from the condensable higher materials can have a wide variety of compositions. The fraction could simply be the gaseous (non-condensed) fraction that includes CO, CO₂, ethylene, propylene, and numerous other components and may include higher olefins. The olefin-containing product could also contain alkynes such as ethyne, propyne, butyne or the like. Alternatively, the fraction could be a relatively olefin-rich stream that is separated from a relatively olefin-poor stream. Examples of separation techniques that can be used in a polymer conversion system include cryogenic separation, distillation, membrane separation, adsorptive separation, or reactive separation. An olefin-containing product that is separated from the condensable higher materials in the vapor products comprises at least 20, or at least 50, or at least 70, or in the range of 20 to 95, or 50 to 90, or 70 to 90 mass % olefins, or more. Other gases in the olefin-containing product could include methane, ethane, propane, butanes, CO, CO₂, water, propadiene, methyl acetylene, H2, or N2, or some combination thereof. The mass yield of olefins may be at least 1%, or at least 2.5%, or at least 5%, or at least 8%, or at least 9%, or no more than 40%, or no more than 25%, or no more than 15%, or from 1% to 40%, or from 3% to 28%, or from 5% to 15%, and the mass yield of all products is no more than 100% based on the mass of solid hydrocarbonaceous materials fed. A stream comprising C5+ products can be separated from the vapor products. In some embodiments, a stream comprising benzene, toluene, xylenes, or some combination of these (BTX) is separated from the vapor products. Mass yield of BTX may be at least 16%, at least 22%, at least 30%, at least 40%, at least 50%, at least 55%, or at least 60%, or from 15% to 75%, from 20% to 70%, or from 45% to 65%. and the mass yield of all products is no more than 100% based on the mass of solid hydrocarbonaceous materials fed to the process. The mass yield of coke and char may be less than 10%, less than 5%, less than 2%, less than 1%, or less than 0.5%, or from 0.1% to 10%, from 0.2% to 5%, or from 0.3 to 2%, and the mass yield of all products is no more than 100% based on the mass of solid hydrocarbonaceous materials fed. The mass yield of olefins plus aromatics can be greater than 40%, greater than 60% greater than 70%, greater than 75%, or greater than 80%, or from 40% to 99%, from 60% to 95%, or from 65% to 90%, and the mass yield of all products is no more than 100% based on the mass of solid hydrocarbonaceous materials fed to the process. The selectivity of ethylene as a percentage of the total olefins produced can be at least 20%, at least 25%, or at least 30%, or from 10% to 60%, from 20% to 45%, or from 25% to 35%, and the selectivity of propylene as a percentage of the total olefins produced is at least 20%, at least 30%, at least 40%, or at least 45%, or at least 50%, or from 20% to 70%, from 25% to 65%, or from 28% to 55%, such that the total selectivity of ethylene plus propylene is less than 100%. In some embodiments the selectivity of benzene plus toluene plus xylenes as a percentage of aromatics produced can be at least 40%, at least 50%, at least 80%, at least 90%, at least 95%, or at least 97%, or from 40% to 99.9%, from 50% to 99.5%, from 80 to 99%, or from 95% to 98%.

Olefin mixtures produced by the inventive process can be separated and purified by conventional cryogenic distillation, membrane separation, hybrid membrane distillation, selective adsorption, or facilitated transport systems as are known in the art. Impurities such as CO₂, HCl, HCN, or H₂S can be removed by amine scrubbing or caustic scrubbing or other conventional means known to those skilled in the art. Removal of impurities can be optionally performed before or after the separation of the olefins from the other vapor components. Aromatics mixtures produced by the inventive process can be separated and purified by conventional distillation, membrane separation, hybrid membrane distillation, selective adsorption, or facilitated transport systems as are known in the art. Impurities such as phenols, thiols, thiophenes, nitriles, amines, or other oxygen, sulfur, or nitrogen containing impurities can be removed by hydrotreating or other conventional means known to those skilled in the art. Removal of impurities can be optionally performed before or after the separation of the aromatics from the other condensable components.

In any of the processes described herein, the olefin-containing gas can be partially separated into different fractions for functionalization, to remove non-reactive components, or to purge excess materials.

### EXAMPLES

### Example 1

Upon entering the fluidized bed reactor, it is important that the plastic particles to quickly sink and start mixing into the bed, and not segregate from the catalyst either on top or in clumps within the bed. The mixing/segregation behavior of plastic-catalyst mixtures was investigated in a cold flow experiment. FIG. 5 shows experimental results of different plastic-catalyst mixtures. Experiments were carried out in a 2 inch diameter, 18 inch tall cylindrical cold flow unit, using plastic particles with various particle diameters and at different catalyst:plastic mixing ratios. The plastics were PET (polyethylene terephthalate), PE (polyethylene), and MTU (mixture of plastics). The ratios of catalyst:plastic were 10:1 or 15:1 and the particle size of the plastics were as shown in FIG. 8. Experiments were carried out under superficial gas velocities ranging between 0.05-0.3 m/s. After the material was permitted to mix for a fixed time the fluidization gas was turned off. The material in the cylinder was removed from the top using a vacuum to remove 3 different fractions at approximately 0.05, 0.4, and 0.8 of the height of the bed. The materials were analyzed by ICP to determine the content of plastic and catalyst.

The mixing index represents the ratio of the local plastics concentration in the bed to the overall average concentration of plastics in the mixture, therefore having a mixing index much higher than 1 (>2) at either the bottom or the top of the bed is a sign of severe segregation. As can be seen in FIG. 8, segregation was not observed for any of the investigated plastic particles, and the mixing index for all species ranged between 0.7-1.4, indicating that good mixing was always observed in the setup.

### Example 2

Computational Fluid Dynamics (CFD) calculations were conducted for two different arrangements of the particle distribution system using nozzles similar to those in FIG. 4. These arrangements are depicted in FIG. 9. A CFD analysis was performed using 3 mm diameter spherical particles with density of BB fed at a rate of XX grams of particles into a bed of YY grams of catalyst using injection nozzles. The fluidized bed in the CFD was set to be particles of ZZ diameter and AA density. The CFD results in FIG. 10 (A) show that the underbed feeding causes the particles to condense soon after their entrance into the bed and then slowly shrink by pyrolyzing as they rise in the bed reaching a minimum diameter of 1 mm. The overbed feeding results in some condensation of particles at or near the top of the bed and progressively smaller particles as they pyrolyze at lower reaches of the bed until they are completely pyrolyzed (diameter=0) at the bottom of the bed. This shows that the overbed feeding can completely decompose the feed particles.

The results in FIG. 10 (B) show that the mixing index of underbed particles increases, and is quite high as they enter the bed, i.e., 1.8 at 0.2 m height, and then declines to a minimum of 0.6 as the particles pyrolyze as they rise through the bed. For the overbed fed case the mixing index starts high as they enter the bed, i.e., 1.8 at 2.5 m height, but continuously declines as they fall and decompose through the bed to reach a minimum of 0.15. The lower mixing index with the overbed feeding scheme indicates better heat transfer to the particles and less segregation than with the underbed fed scheme.

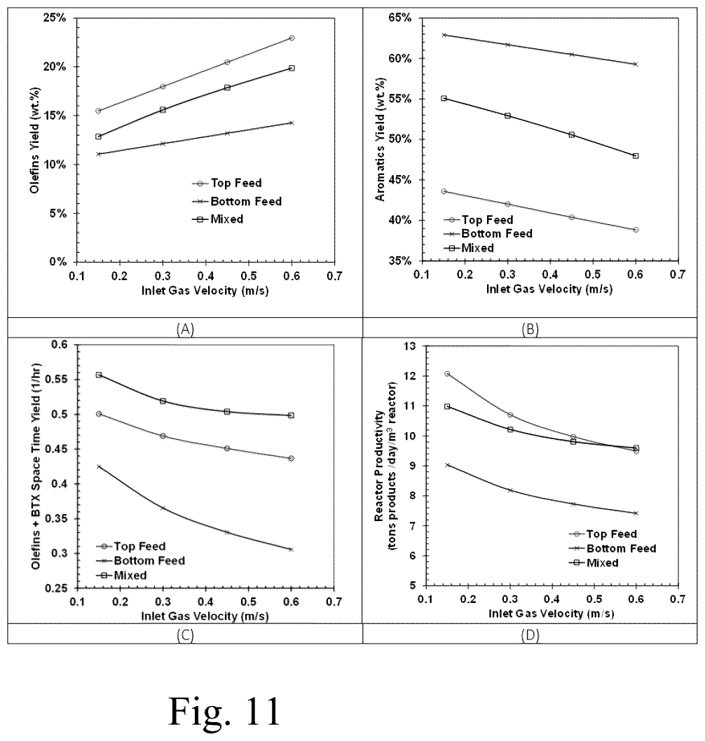

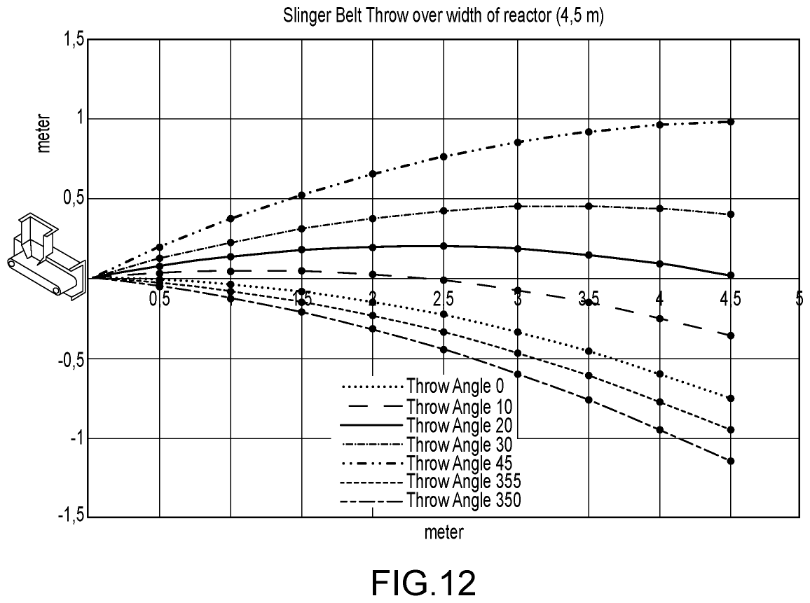

The distributions of feed materials in the overbed and underbed feed cases are presented in FIGS. 11 and 12. The underbed (bottom) feed depicted in FIG. 11 shows that the feed (left) will be very concentrated near the outlets of the nozzles. For particles that are sticky or that involve melting before they decompose into vapors, such as plastics or biomass, this will strongly favor condensation into large particles. The large particles will be very slow to decompose by pyrolysis since heat transfer is slower for larger particles that have a smaller surface/volume ratio. These larger particles will spend a very long time in the fluid bed, reducing the space time yield (reactor productivity) of the process. This may also limit the rate that feed can be added since additional feed will further increase the size of these conglomerates. By contrast, in FIG. 12, with an overbed feed system, there is relatively little concentration and condensation of feed as it enters the bubbling bed of catalyst. The particles remain separated and are rapidly diluted by the catalyst as they shrink due to pyrolysis. Further introduction of feed into the bed is possible because the surface of the bubbling bed is highly agitated.

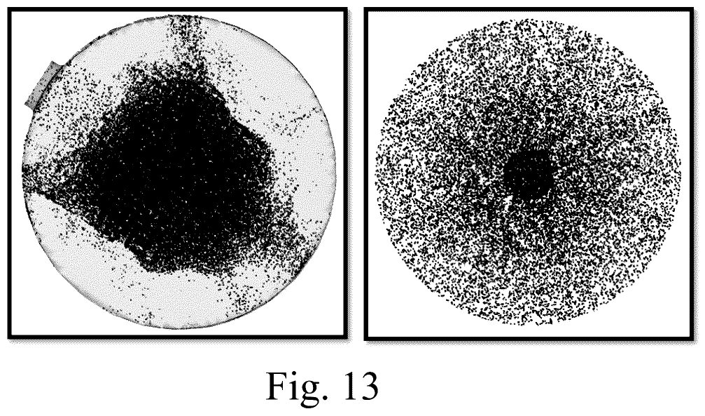

The performance of the catalytic pyrolysis reactor was compared for top feeding, bottom feeding, and a theoretically perfectly mixed case as a function of the inlet fluidization gas velocity with CFD. The results are presented in FIG. 13. For top and bottom feeding, the experimental mixing profiles as measured in the cold flow unit were used to represent the mixing profiles in the model. The reactor model used in this assessment is a compartment-type fluidized bed model incorporating both hydrodynamic and kinetic behaviors, as has been discussed extensively in the literature.

Provided one assumes that no defluidization occurs due to local plastics concentration in the case of bottom feeding, the yields of olefins and aromatics (FIGS. 13 (A) and (B)) and reactor productivities (space time yield, FIGS. 13 (C) and (D)) were calculated by CFD using a compartment-type reactor model for top and bottom feeding arrangements. Compared to bottom feeding, top feeding results in a higher olefins yield by as much as 10 wt. % and a lower aromatics yield. This is primarily due to the thermal pyrolysis gas having a longer contact time with the catalyst for the bottom-feeding configuration, which results in an increase in aromatics yield due to olefin aromatization.

As shown in FIGS. 13 (C) and (D), reactor productivity (space-time yield), when considering only olefins and aromatics, is consistently about 30% higher for the top feed compared to the bottom feed design. Generally, for the same reactor size operating under the same conditions, overbed feeding will generate a significantly higher product yield compared to underbed feeding (FIG. 11 (C) and (D)).

### Example 3

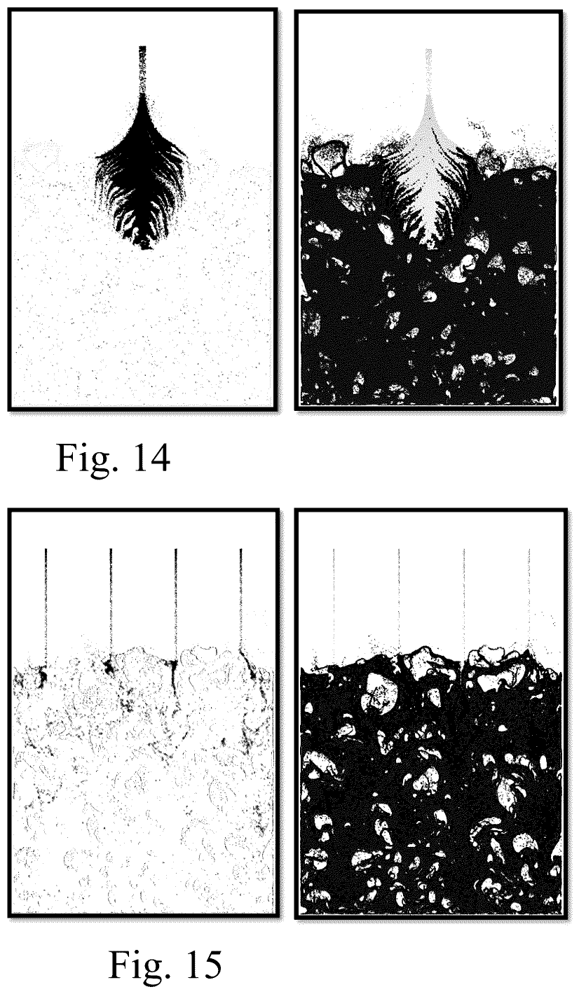

A CFD study was undertaken on the performance of a slinger feed system. A slinger that propels AAA grams per minute of XXX mm diameter, ZZZ density particles from the edge over a 4.5 m diameter fluid bed with LLL bara pressure of vapor in the system was evaluated. The distance of throw of the particles was calculated as a function of throw angle (the angle above the horizontal at which the particles are thrown) for a slinger feeder and is presented in FIG. 14. The angle of the slinger feeder can be chosen to best fit the diameter of the fluid bed reactor. For a 4.5 m diameter reactor the angle is preferred to be between X and Y degrees from the horizontal.

CFD was used to compare the calculated distributions of particles from a slinger belt feeder and a single conical feeder when used in overbed feeding design reactor 4.5 m in diameter. The slinger feeder was assumed to be positioned FFF meters above the fluid bed angled at 35 degrees above horizontal, and the conical feeder was positioned GGG meters above the fluid bed. The calculated time averaged CFD results of the radial distribution particles are presented in FIG. 15. While both designs distribute the particles across the entire surface of the bed, the cross-sectional distributions in FIG. 15 show that a single conical feeder puts most of the particles within a circle of about 0.5 m in diameter with a few spread further afield. The slinger belt feeder spreads the bulk of the particles over a circle of about 3 m in diameter. Thus, a single slinger feeder provides much wider and more uniform distribution of particles than a single conical feed nozzle in an overbed design. Multiple conical nozzles would be needed to provide a similar breadth of distribution of particles as a single slinger feeder.

### Example 4

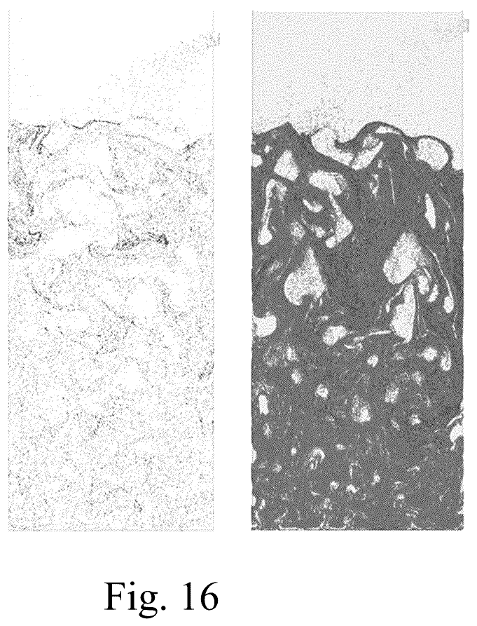

A CFD evaluation of single nozzle, multiple nozzle (10 nozzles), and slinger feed systems was conducted. The axial mixing profiles of the single nozzle, multiple (10) nozzle, and slinger belt feeder are compared in FIGS. 16, 17, and 18. In these calculations, the same rate of feed was assumed for each configuration. For the single nozzle feeding system depicted in FIG. 16, there is a clear concentration and agglomeration of the plastic particles at the point of contact between the plastic feed and the fluidized bed. This single point of contact results in a locally high concentration of plastics, which both promotes agglomeration and segregation of the plastic feed in the bed. Eventually, the rate of plastic melting and agglomeration becomes faster than the rate of thermal pyrolysis of the outer layer, potentially resulting in the defluidization of the top of the reactor bed. This problem can be partially solved by introducing multiple nozzles as shown in FIG. 17. This approach significantly reduces the plastics agglomeration and decreases plastics concentration at the point of contact with the bed, however, there remain small pockets of agglomerated plastics at the point of contact. These local high concentrations of plastics are likely to cause an increased yield of heavies and coke from the pyrolysis reaction.

The performance of the slinger belt is shown in FIG. 18. Clearly there are no local pockets of plastic agglomeration at the point of contact with the bed. This is primarily due to the particles being individually distributed over a larger cross-sectional area of the bed, without having high concentration points of feeding/contact with the surface of the fluidized bed.

Furthermore, it is important to note that when using nozzles, the nozzles can be cooled to prevent the plastic containing feedstock from softening or melting prior to entering the fluidized bed. This will require constant circulation of water or other coolant through the annular space of the nozzles, and yet there remains a risk of improper cooling or blocking of one or more nozzles. Such configurations increase the complexity when designing a multiple nozzle configuration, while producing a lesser yield than the slinger belt distributor design.

### EXAMPLE 5

The performance of several different overbed feed designs was compared using CFD, and the results are summarized in Table 2. As can be seen, the single nozzle configuration results in a significantly higher yield of heavies and coke compared to the other configurations. This effect is somewhat reduced with the multiple nozzle configuration but heavies and coke yields remain much higher compared to the slinger belt and nozzle with conical distributor configurations. On the other hand, when comparing the Olefins +Aromatics yields the single and multiple nozzle configurations generate 21.2 wt. % and 51.52 wt. %, respectively, which is significantly lower than the slinger belt and nozzle with conical distributor which yield, 68.6 wt. % and 68.58 wt. % Therefore the proposed configurations will yield a significant improvement in reactor performance.

TABLE 2
Performance of catalytic pyrolysis of plastic
using various overbed feed designs.

| | | | | Nozzle with |
|---|---|---|---|---|
| Species | Single | Multiple | Slinger | Conical |
| (wt %) | Nozzle | Nozzles | Belt | Distributor |
| Permanent Gas | 7.70% | 6.08% | 5.30% | 4.73% |
| Paraffins | 18.62% | 17.60% | 17.20% | 18.06% |
| Olefins | 12.72% | 27.01% | 36.60% | 38.43% |
| Aromatics | 8.47% | 24.51% | 32.00% | 30.15% |
| Coke | 18.89% | 9.00% | 4.70% | 4.10% |
| Unknowns/Heavies | 33.60% | 15.80% | 4.20% | 4.53% |
| Total | 100.00% | 100.00% | 100.00% | 100.00% |

1. A process for converting solid hydrocarbonaceous materials to useful products comprising:
a) feeding solid hydrocarbonaceous materials into a fluidized bed catalytic pyrolysis reactor containing a solid conversion catalyst by means of a feed system that includes a particle distribution device that spreads feed particles over the surface of the bed,
b) reacting the hydrocarbonaceous materials to form vapor products,
c) withdrawing and recovering the vapor products, and
d) recovering olefins, aromatics, or both, from the vapor products.

2. The process of claim 1 wherein the solid hydrocarbonaceous materials are selected from among polyethylene (PE), polypropylene (PP), polyacetylene, polybutylene, polyolefins, polyethylene terephthalate (PET), polybutylene terephthalate, copolyesters, polyester, polycarbonate, polyurethanes, polyamides, polystyrene (PS), polyacetal, epoxies, polycyanurates, polyacrylics, polyurea, vinyl esters, polyacrylonitrile, polyvinyl alcohol, polyvinylchloride (PVC), poly(methyl methacrylate) (PMMA), polyvinyl acetate, nylon, copolymers such as: ethylene-propylene, EPDM, acrylonitrile-butadiene-styrene (ABS), nitrile rubber, natural and synthetic rubber, tires, styrene-butadiene, styrene-acrylonitrile, styrene-isoprene, styrene-maleic anhydride, ethylene-vinyl acetate, nylon 12/6/66, filled polymers, polymer composites, polymer composites comprising natural fibers, plastic alloys, other polymeric materials, whether obtained from polymer or plastic manufacturing processes as waste or discarded materials, post-consumer recycled polymer materials, biomass, materials separated from waste streams such as municipal solid waste, black liquor, wood waste, or other biologically produced materials, or a combination of these.

3. The process of claim 1 wherein the solid hydrocarbonaceous material comprises material selected from among polyethylene, polypropylene, and polystyrene, or mixtures thereof.

4-8. (canceled)

9. The process of claim 1 wherein at least a portion of the chlorine-containing plastics are selectively removed from the feed mixture.

10-13. (canceled)

14. The process of claim 1 wherein the feed system comprises a feed hopper, a metering device, and a distributor that spreads the feed materials over the top of the fluidized bed.

15-16. (canceled)

17. The process of claim 1 wherein the distributor propels the feed particles above and across the cross-section of the surface of fluidized bed reactor.

18. The process of claim 17 wherein the distributor propels the feed particles by spinning to impart radial velocity to the particles.

19-34. (canceled)

35. The process of claim 1 wherein used catalyst and solids are withdrawn from the catalytic reactor.

36. The process of claim 35 wherein at least a portion of the withdrawn used catalyst and any solids are fed to a catalyst regenerator.

37-39. (canceled)

40. The process of claim 1 wherein the vapor products are separated from entrained catalyst and solids in one or more cyclones.

41-50. (canceled)

51. The process of claim 1 wherein the catalyst comprises a zeolite.

52-58. (canceled)

59. The process of claim 1 wherein an olefin-containing product stream that comprises at least 20, at least 50, or at least 70, or in the range of 20 to 95, 50 to 90, or 70 to 90 mass % olefins, or more is separated from the condensable higher materials in the vapor products.

60-61. (canceled)

62. The process of claim 1 wherein a stream comprising benzene, toluene, xylenes, or some combination of these (BTX) is separated and recovered from the vapor products.

63-65. (canceled)

66. The process of claim 1 wherein the selectivity of benzene plus toluene plus xylenes (BTX) as a percentage of aromatics produced is at least 40%, at least 50%, at least 80%, at least 90%, at least 95%, or at least 97%, or from 40% to 99.9%, from 50% to 98%, from 80 to 95%, or from 90% to 95%.

67. (canceled)

68. The process of claim 36 wherein the vapor products mixture is subjected to a separation process to produce a separated stream of gases comprising gases chosen from among any of C1 to C4 hydrocarbons, H₂, CO₂, and CO, or some combination thereof. and passing at least a portion of the separated stream of gases to the regenerator as part of the fluidization fluid.

69-75. (canceled)

76. The process of claim 1 wherein at least a portion of the solid hydrocarbonaceous materials are melted in a thermal pyrolysis reactor and at least a portion of the molten liquid is fed to the catalytic pyrolysis reactor.

77. The process of claim 76 wherein the thermal pyrolysis reactor comprises an extruder, rotating kiln reactor, or other suitable reactor that produces a molten liquid stream.

78. The process of claim 76 wherein the thermal pyrolysis reactor comprises an added solid.

79. The process of claim 78 wherein the solid added to the thermal pyrolysis reactor comprise a calcium or magnesium salt.

80-86. (canceled)

87. An apparatus for converting solid hydrocarbonaceous materials to useful products comprising:
a) a feed hopper comprising solid hydrocarbonaceous materials comprising polymers or biomass or both,
b) a fluidized bed catalytic pyrolysis reactor containing a conversion catalyst,
c) a particle distribution device positioned to feed the solid hydrocarbonaceous materials into the fluidized bed catalytic pyrolysis reactor at a point in the reactor above the height of a dense bubbling phase of the fluid bed,
d) a conduit adapted to feed hot regenerated catalyst at a point in the reactor above the height of the dense bubbling phase of the fluid bed,
e) a conduit adapted to pass the vapors from the fluid bed into one or more cyclones in which entrained particles are removed,
f) a conduit adapted to withdraw catalyst and solids from the catalytic reactor,
g) a conduit adapted to feed used catalyst and any solids withdrawn from the catalytic reactor to a fluidized bed catalyst regenerator,
h) a conduit adapted to withdraw hot, regenerated catalyst from the regenerator, and
i) one or more cyclones through which the hot regenerated catalyst and combustion products can be passed to separate the solids.
